(19) United States
(12) Patent Application Publication
(10) Pub. No.: US 2021/0102122 A1
(43) Pub. Date: Apr. 8, 2021

(54) LIQUID CRYSTAL MEDIUM

(71) Applicant: Merck Patent GmbH, Darmstadt (DE)

(72) Inventors: Michael WITTEK, Erzhausen (DE); Dagmar KLASS, Darmstadt (DE)

(73) Assignee: Merck Patent GmbH, Darmstad (DE)

(21) Appl. No.: 16/608,304

(22) PCT Filed: Apr. 24, 2018
(86) PCT No.: PCT/EP2018/060401

§ 371 Date: Oct. 25, 2019

(30) Foreign Application Priority Data
Apr. 27, 2017 (DE) 10 2017 004 059.1

(51) Int. Cl. C09K 19/44; C09K 19/30; C09K 19/34

(52) U.S. Cl. CPC C09K 19/44; C09K 19/3003; C09K 2019/0455; C09K 19/3402; C09K 19/3028

(57) ABSTRACT

The invention relates to a liquid-crystalline medium comprising one or more compounds of the formula CC

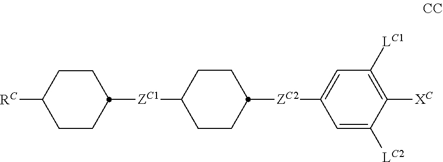

in which the groups occurring have the meanings indicated in Claim 1, and to the use of the liquid-crystalline medium for electro-optical purposes, in particular in liquid-crystal light valves for lighting devices for vehicles, and to liquid-crystal light valves which comprise this medium and lighting devices for vehicles which contain liquid-crystal light valves of this type.

The present invention relates to a liquid-crystalline medium and to the use thereof for electro-optical purposes, in particular for liquid-crystal light valves for use in lighting devices for vehicles, to liquid-crystal light valves containing this medium, and to lighting devices based on such liquid-crystal light valves.

Liquid crystals are used, in particular, as dielectrics in display devices, since the optical properties of such substances can be influenced by an applied voltage. Electro-optical devices based on liquid crystals are extremely well known to the person skilled in the art and may be based on various effects. Devices of this type are, for example, TN cells having a twisted nematic structure or STN (“super-twisted nematic”) cells. Modern TN and STN displays are based on an active matrix of individually addressable liquid-crystal light valves (the pixels) with integrated red, green and blue coloured filters for additive generation of the colour images.

The electro-optical effects utilised in liquid-crystal displays have recently also been used for other applications.

DE 19910004 A1 describes LCD screens as shade for adjusting the brightness distribution of lighting devices for motor vehicles as desired, by means of which the brightness distribution is to be adapted to the driving situation in a flexible manner.

Adaptive lighting systems of this type for motor vehicles (adaptive front lighting system, AFS) generate headlamp light which is adapted to the particular situation and ambient conditions and are capable of reacting, for example, to the light and weather conditions, the movement of the vehicle or the presence of other road users, in order to illuminate the environment constantly and optimally and avoid adversely affecting other road users. U.S. Pat. No. 4,985,816 discloses, for example, components in which a spatial light modulator in the form of a liquid-crystal display (LCD) plate consisting of a matrix of light-transmitting elements, analogously to the pixels of a liquid-crystal display, generates electrically switchable, complete or partial shading of the light cone with the aim of avoiding or reducing dazzling of the drivers of oncoming vehicles. Spatial light modulators of this type are, as already mentioned, also known as liquid-crystal light valves. Owing to the similar way of functioning as in projectors, the term projector-type vehicle lighting is also used. The image information for controlled shading of the light cone is preferably supplied here by a digital camera.

A liquid-crystal light valve in the sense of the present invention may include a single area for modulation of the light or a matrix of a multiplicity of identical or different part-areas corresponding to the pixels of a liquid-crystal display. A matrix of liquid-crystal light valves thus represents a special case of a monochrome matrix liquid-crystal display or can be regarded as a part thereof.

A lighting device in the sense of the invention is, in particular, an AFS or part of an AFS. A lighting device in the sense of the invention serves, in particular, for the illumination of an area in front of a vehicle or motor vehicle.

Vehicles in the sense of the invention are very generally means of transport, such as, for example, but not restricted to, aircraft, ships, and land vehicles, such as automobiles, motorcycles and bicycles, as well as rail-bound land vehicles, such as locomotives.

Motor vehicle in the sense of the invention is, in particular, a land vehicle which can be used individually in road traffic. Motor vehicles in the sense of the invention are, in particular, not restricted to land vehicles having a combustion engine.

In the liquid-crystal light valve disclosed in the above-mentioned U.S. Pat. No. 4,985,816, a TN cell is used as optical modulation element, which displays pixels in accordance with the desired brightness profile of the vehicle lighting, where, for example, an addressing voltage is applied to the TN liquid-crystal for modulation (control) of the degree of transmission of a pixel. Owing to the polarisers that are necessary there, only about half of the light of the light source can be utilised. An alternative, which is likewise based on a TN cell, which enables more than only half of the light of the light source of the lighting device to be rendered useful is disclosed in DE 10 2013 113 807 A1. In this, the light is divided into two part-beams having planes of polarisation perpendicular to one another by means of a polarising beam splitter and guided through two separate liquid-crystal elements which can be switched separately from one another.

Lighting devices of this type are distinguished by comparatively high operating temperatures of typically 60-80° C., which makes particular demands of the liquid-crystal media used: the clearing points must be higher than 120° C., preferably higher than 140° C., and, owing to the strong exposure to light, these media must have particularly high light stability. This may under certain circumstances be favoured, for example, by the use of materials having extremely low birefringence. The liquid-crystal materials must, in addition, have good chemical and thermal stability and good stability to electric fields. Furthermore, the liquid-crystal materials should have low viscosity and give rise to relatively short addressing times, the lowest possible operating voltages and high contrast in the cells.

Furthermore, they should have a suitable mesophase, for example for the above-mentioned cells a nematic or cholesteric mesophase, at usual operating temperatures, i.e. in the broadest possible range below and above room temperature, preferably from −40° C. to 150° C. Since liquid crystals are generally used in the form of mixtures of a plurality of components, it is important that the components are readily miscible with one another. Further properties, such as the electrical conductivity, the dielectric anisotropy and the optical anisotropy, have to meet different requirements depending on the cell type and area of application. For example, materials for cells having a twisted nematic structure should have positive dielectric anisotropy and low electrical conductivity.

For example, media having large positive dielectric anisotropy, broad nematic phases, relatively low birefringence, very high specific resistance, good light and temperature stability and low vapour pressure are desired for light valves in matrix liquid-crystal displays having integrated non-linear elements for switching individual pixels (MLC displays). Matrix liquid-crystal displays of this type are known, and the design principle can also be used for the lighting device according to the invention.

Examples of non-linear elements which can be used to individually switch the individual pixels are active elements (i.e. transistors). The term “active matrix” is then used, where a distinction can be made between two types:
1. MOS (metal oxide semiconductor) or other diodes on silicon wafers as substrate.
2. Thin-film transistors (TFTs) on a glass plate as substrate.

The use of single-crystal silicon as substrate material restricts the display size, since even modular assembly of various part-displays results in problems at the joints.

In the case of the more promising type 2, which is preferred, the electro-optical effect used is usually the TN effect. A distinction is made between two technologies: TFTs comprising compound semiconductors, such as, for example, CdSe, or TFTs based on polycrystalline or amorphous silicon. Intensive work is being carried out worldwide on the latter technology.

The TFT matrix is applied to the inside of one glass plate of the display, while the other glass plate carries the transparent counterelectrode on the inside. Compared with the size of the pixel electrode, the TFT is very small and has virtually no adverse effect on the image.

The TFT displays and corresponding light valves for lighting devices usually operate as TN cells with crossed polarisers in transmission and are backlit.

The term MLC displays here encompasses any matrix display with integrated non-linear elements, i.e., besides the active matrix, also displays with passive elements, such as varistors or diodes (MIM=metal-insulatormetal).

Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff, Paris; STROMER, M., Proc. Eurodisplay 84, September 1984: Design of Thin Film Transistors for Matrix Addressing of Television Liquid Crystal Displays, pp. 145 ff, Paris]. With decreasing resistance, the contrast of an MLC display deteriorates, and the problem of after-image elimination may occur. Since the specific resistance of the liquid-crystal mixture generally drops over the life of an MLC display owing to interaction with the interior surfaces of the display, a high (initial) resistance is very important in order to obtain acceptable lifetimes. In particular in the case of low-volt mixtures, it was hitherto impossible to achieve very high specific resistance values. It is furthermore important that the specific resistance exhibits the smallest possible increase with increasing temperature and after heating and/or exposure to light. This is also relevant on use of light valves in lighting devices for vehicles, since the liquid crystal therein is subjected to high temperatures and light levels, and a low specific initial resistance and a rapid increase in the specific resistance on exposure generally correlates with low long-term stability.

The low-temperature properties of the mixtures from the prior art are also particularly disadvantageous. It is required that no crystallisation and/or smectic phases occur, even at low temperatures, and the temperature dependence of the viscosity is as low as possible. The MLC displays from the prior art thus do not satisfy the requirements for use in lighting devices.

There is thus still a great demand for liquid-crystal mixtures having very high specific resistance at the same time as a large working-temperature range and high light stability.

In the case of liquid-crystal light valves for lighting devices for vehicles, media are desired which facilitate the following advantages in the cells:
extended nematic phase range (in particular to high temperatures)
stable on storage, even at low temperatures
switchability at low temperatures
increased light stability.

With the media available from the prior art, it is not possible to achieve these advantages while simultaneously retaining the other parameters. For example, liquid-crystal media of the published specifications DE 102 23 061 A1 and DE 10 2008 062858 A1 have a low Δn, but the clearing points of around 80° C. are in a range which is too low for the application according to the invention.

The invention is based on the object of providing media, in particular for the above-mentioned liquid-crystal light valves for lighting devices for vehicles, which do not have the disadvantages indicated above or any do so to a lesser extent, and preferably at the same time have very high clearing points and low birefringence.

It has now been found that this object can be achieved if media according to the invention are used in liquid-crystal components. The invention relates to a liquid-crystalline medium, characterised in that it comprises one or more compounds of the formula CC

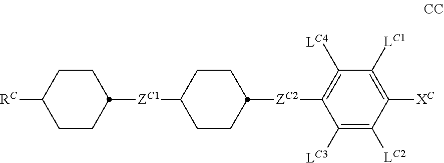

preferably in a total concentration of 35% or more,
in which
R^{C} denotes an alkyl, alkenyl or alkoxy radical having 1 to 15 C atoms, in which a methylene group may be replaced by

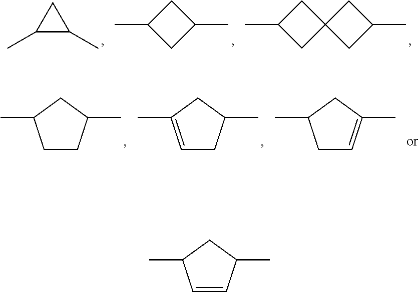

and in which in each case one or more H atoms may be replaced by F,
X^{C} denotes F, Cl, a halogenated alkyl radical, a halogenated alkenyl radical, a halogenated alkoxy radical or a halogenated alkenyloxy radical having up to 6 C atoms,
Z^{C1} and Z^{C2}, independently of one another, denote —CH₂CH₂— or a single bond,
L^{C1} and L^{C2}, independently of one another, denote H or F
L^{C3} und L^{C4} independently of one another, H or methyl;
   and characterised in that the medium has a clearing point of 120° C. or more.

In the present application, all atoms also include their isotopes. In particular, one or more hydrogen atoms (H) may be replaced by deuterium (D), which is particularly preferred in some embodiments; a high degree of deuteration enables or simplifies analytical determination of compounds, in particular in the case of low concentrations.

In the present application, alkyl or alkoxy denotes a straight-chain or branched alkyl or alkoxy radical. It is preferably straight-chain, has 2, 3, 4, 5, 6 or 7 carbon atoms and accordingly preferably denotes ethyl, propyl, butyl, pentyl, hexyl, heptyl, ethoxy, propoxy, butoxy, pentoxy, hexoxy or heptoxy, furthermore methyl, octyl, nonyl, decyl, undecyl, dodecyl, tridecyl, tetradecyl, pentadecyl, methoxy, octoxy, nonoxy, decoxy, undecoxy, dodecoxy, tridecoxy or tetradecoxy.

Oxaalkyl preferably denotes straight-chain 2-oxapropyl (=methoxymethyl), 2- (=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl, or 2-, 3-, 4-, 5-, 6-, 7-, 8- or 9-oxadecyl.

An alkyl radical in which a CH₂ group has been replaced by —CH═CH— may be straight-chain or branched. It is preferably straight-chain and has 2 to 10 carbon atoms. Accordingly, it denotes, in particular, vinyl, prop-1- or -2-enyl, but-1-, -2- or -3-enyl, pent-1-, -2-, -3- or -4-enyl, hex-1-, -2-, -3-, -4- or -5-enyl, hept-1-, -2-, -3-, -4-, -5- or -6-enyl, oct-1-, -2-, -3-, -4-, -5-, -6- or -7-enyl, non-1-, -2-, -3-, -4-, -5-, -6-, -7- or -8-enyl, or dec-1-, -2-, -3-, -4-, -5-, -6-, -7-, -8- or -9-enyl.

In an alkyl radical in which one CH₂ group has been replaced by —O— and one has been replaced by —CO—, these are preferably adjacent. This thus contains an acyloxy group —CO—O— or an oxycarbonyl group —O—CO—. These are preferably straight-chain and have 2 to 6 carbon atoms. Accordingly, they denote, in particular, acetyloxy, propionyloxy, butyryloxy, pentanoyloxy, hexanoyloxy, acetyloxymethyl, propionyloxymethyl, butyryloxymethyl, pentanoyloxymethyl, 2-acetyloxyethyl, 2-propionyloxyethyl, 2-butyryloxyethyl, 2-acetyloxypropyl, 3-propionyloxypropyl, 4-acetyloxybutyl, methoxycarbonyl, ethoxycarbonyl, propoxycarbonyl, butoxycarbonyl, pentoxycarbonyl, methoxycarbonylmethyl, ethoxycarbonylmethyl, propoxycarbonyl there are methyl, butoxycarbonylmethyl, 2-(methoxycarbonyl)ethyl, 2-(ethoxycarbonyl)ethyl, 2-(propoxycarbonyl)ethyl, 3-(methoxycarbonyl)propyl, 3-(ethoxycarbonyl)propyl or 4-(methoxycarbonyl)butyl.

Compounds containing branched wing groups R⁰¹ and/or R⁰² may occasionally be of importance owing to better solubility in the conventional liquid-crystalline base materials, but in particular as chiral dopants if they are optically active. Smectic compounds of this type are suitable as components of ferroelectric materials

Branched groups of this type generally contain not more than one chain branch. Preferred branched radicals R are isopropyl, 2-butyl (=1-methylpropyl), isobutyl (=2-methylpropyl), 2-methylbutyl, isopentyl (=3-methylbutyl), 2-methylpentyl, 3-methylpentyl, 2-ethylhexyl, 2-propylpentyl, isopropoxy, 2-methylpropoxy, 2-methylbutoxy, 3-methylbutoxy, 2-methylpentoxy, 3-methylpentoxy, 2-ethylhexoxy, 1-methylhexoxy and 1-methylheptoxy.

In a preferred embodiment, the medium comprises one or more compounds CP

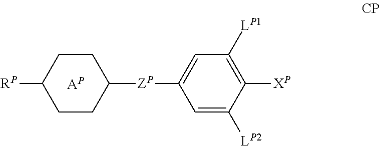

in which
R^{P} denotes an alkyl, alkenyl or alkoxy radical having 1 to 15 C atoms, in which a methylene group may be replaced by

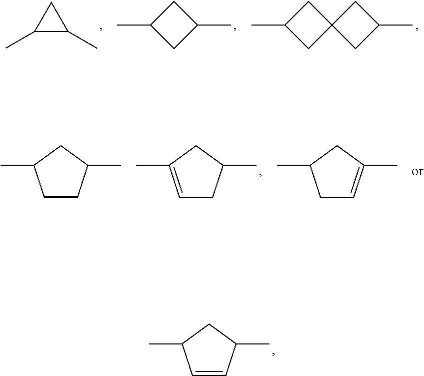

and in which in each case one or more H atoms may be replaced by F,
A^{P} denotes 1,4-cyclohexylene, in which one or two nonadjacent CH₂ groups may be replaced by —O—, or 1,4-phenylene, in which one or two CH groups may be replaced by N,
X^{P} denotes F, C, a halogenated alkyl radical, a halogenated alkenyl radical, a halogenated alkoxy radical or a halogenated alkenyloxy radical having up to 6 C atoms,
Z^{P}, independently of one another, denotes —CH₂CH₂— or a single bond,
L^{P1} and L^{P2}, independently of one another, denote H or F, in a total concentration of 2% or less.

The medium according to the invention particularly preferably comprises one or more compounds of the formula CP in a total concentration of 0.5% or less, very particularly preferably 0.1% or less.

In a preferred embodiment, the medium according to the invention comprises one or more compounds of the formula CP in a total concentration in a range from 0.01% to 2%.

In a further preferred embodiment, the medium comprises no compound of the formula CP.

The compounds of the formula CC are preferably selected from the group of the compounds CC-1 to CC-12, particularly preferably from the group of the compounds CC-1 to CC-6:

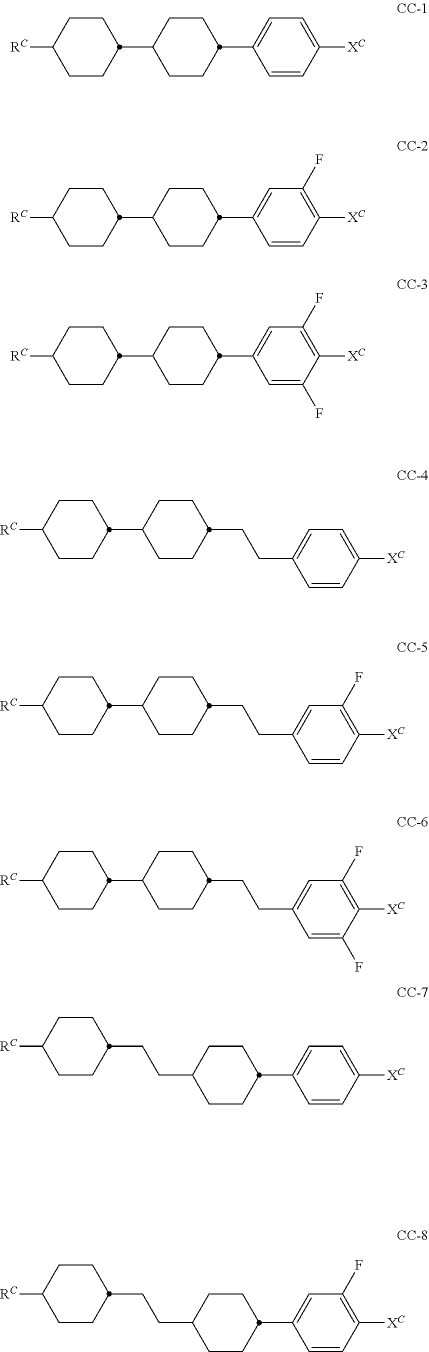

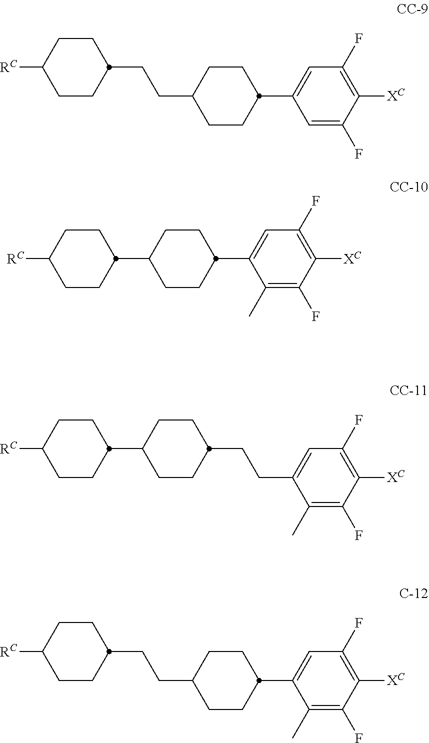

in which R^{C} and X^{C} have the meanings indicated above and preferably
R^{C} denotes unbranched alkyl having 1 to 7 C atoms in which a methylene group may be replaced by

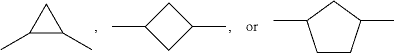

and in which in each case one or more H atoms may be replaced by F, particularly preferably ethyl, n-propyl, n-butyl or n-pentyl, X^{C} denotes F, Cl, OCF₂H or OCH₂CF₂H.

Very particularly preferred compounds of the formulae CC-1 to CC-6 are selected from the sub-formulae CC-1-1 to CC-6-10:

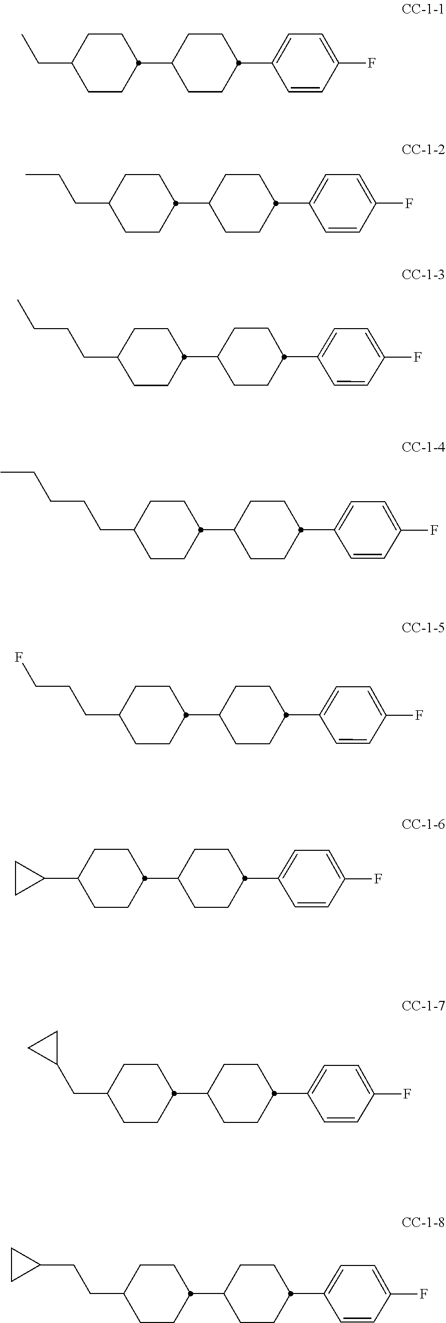

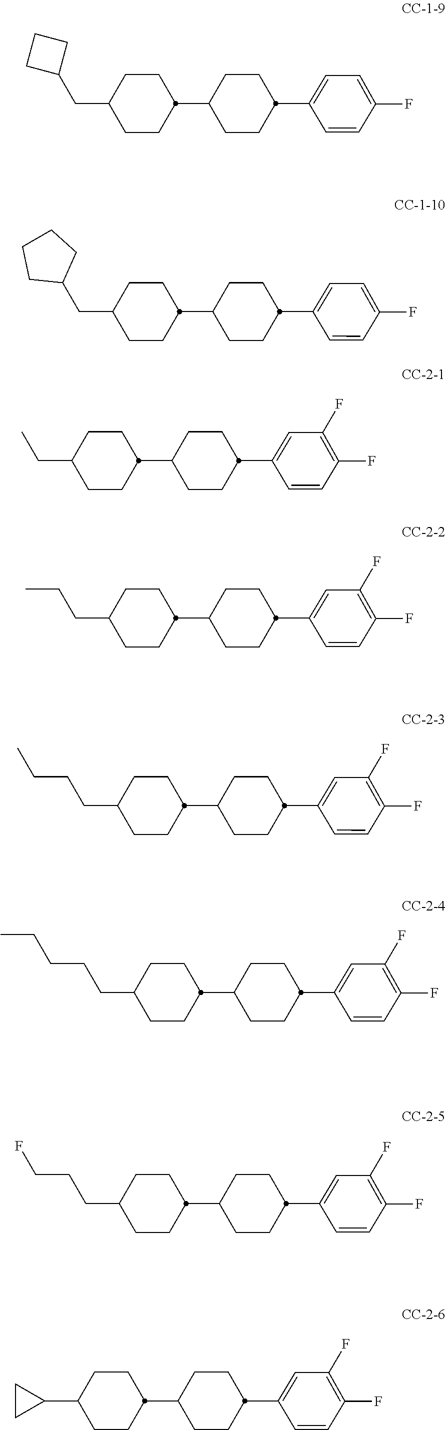

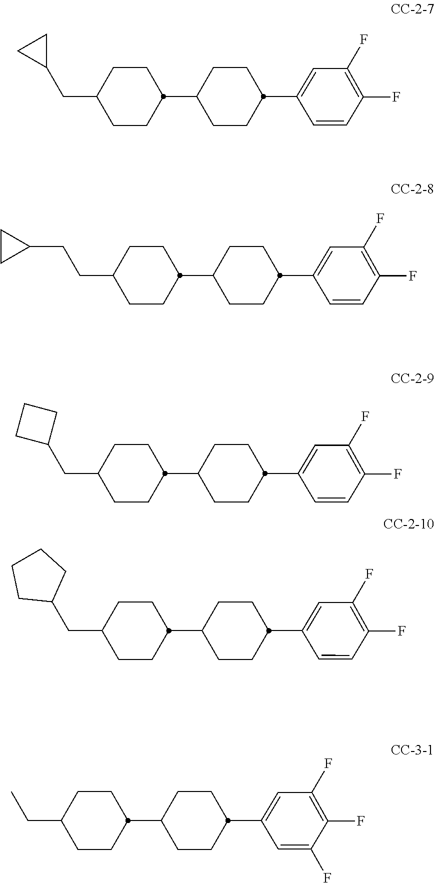

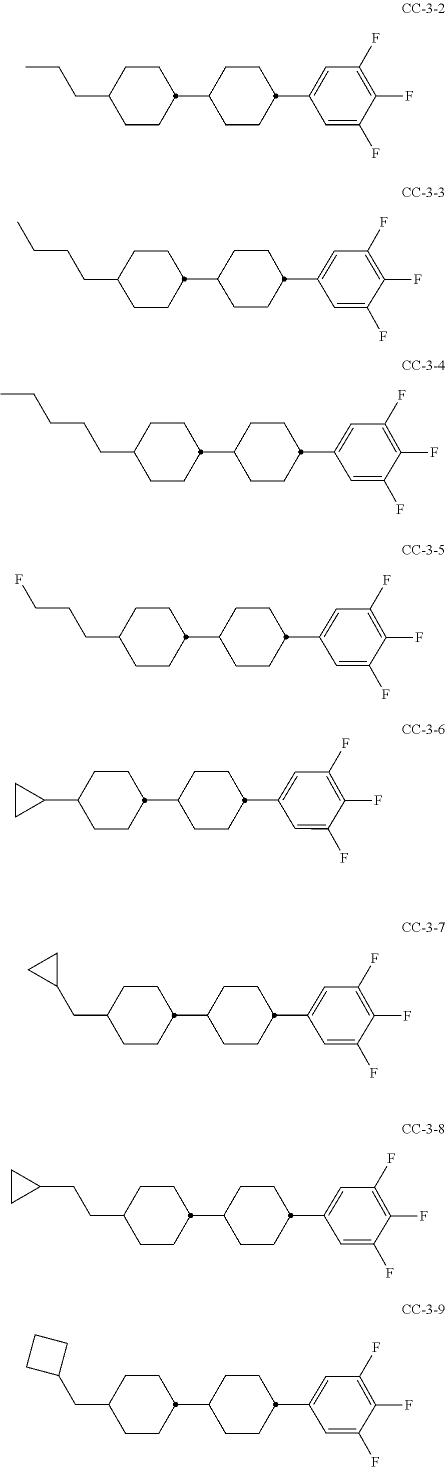

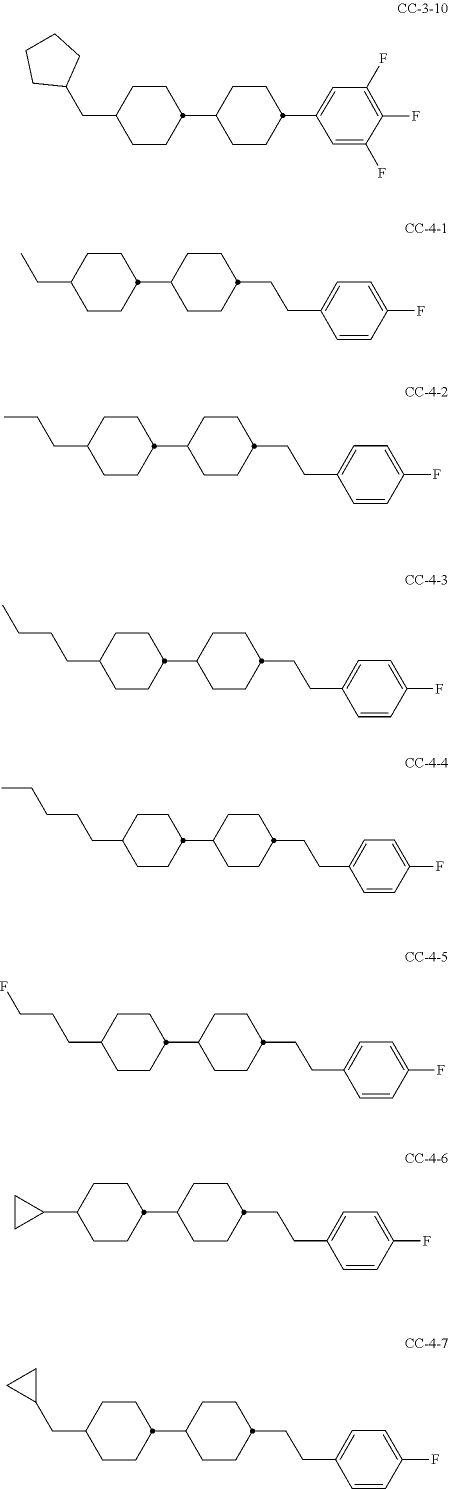

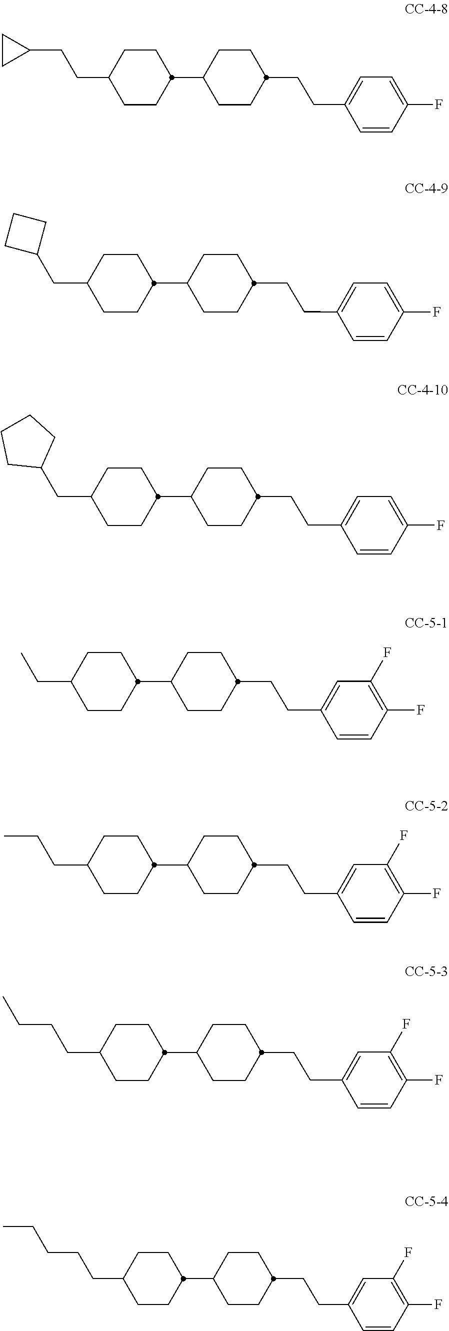

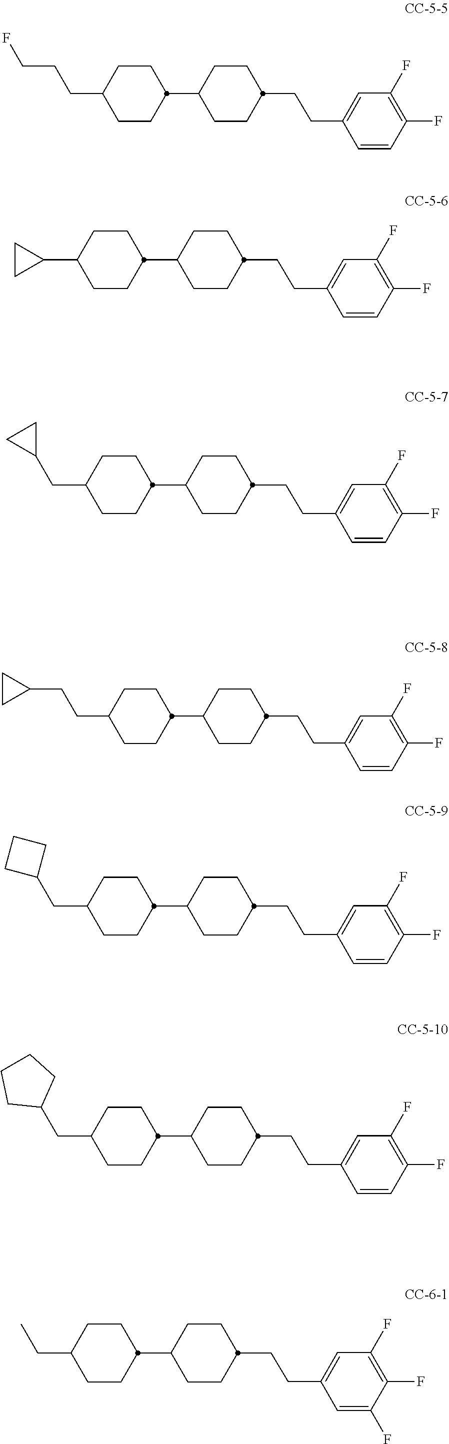

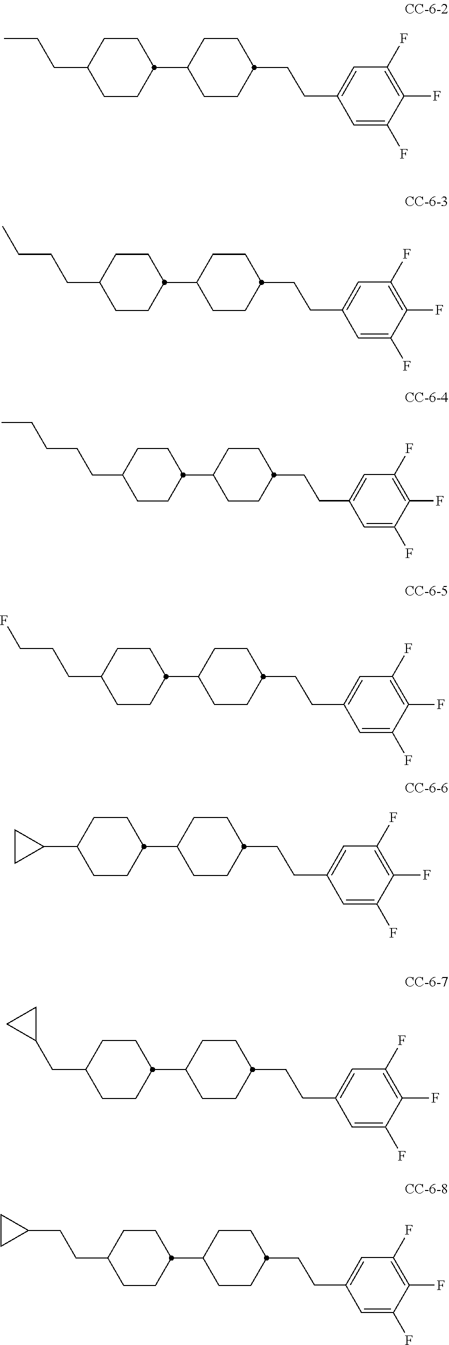

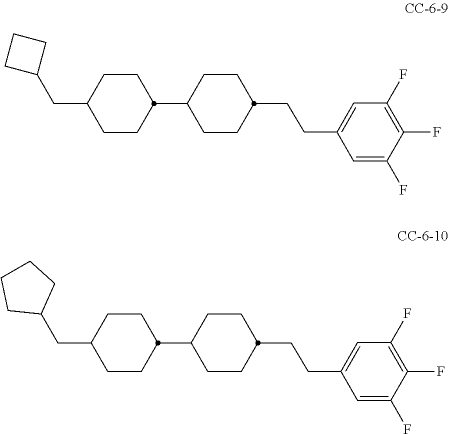

In a particular embodiment, the medium additionally comprises one or more compounds of the formula I

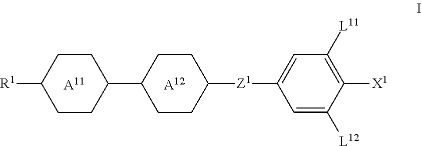

in which
R¹ denotes an alkyl or alkoxy radical having 1 to 15 C atoms, in which a methylene group may be replaced, by

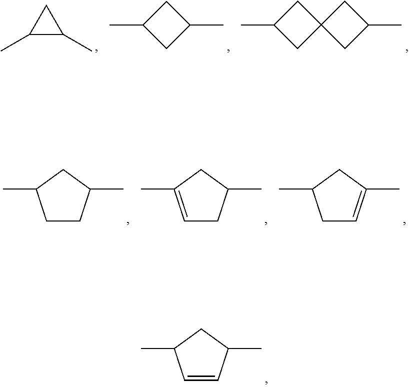

where one or more H atoms in these radicals may be replaced by F

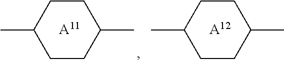

on each occurrence, identically or differently, denote

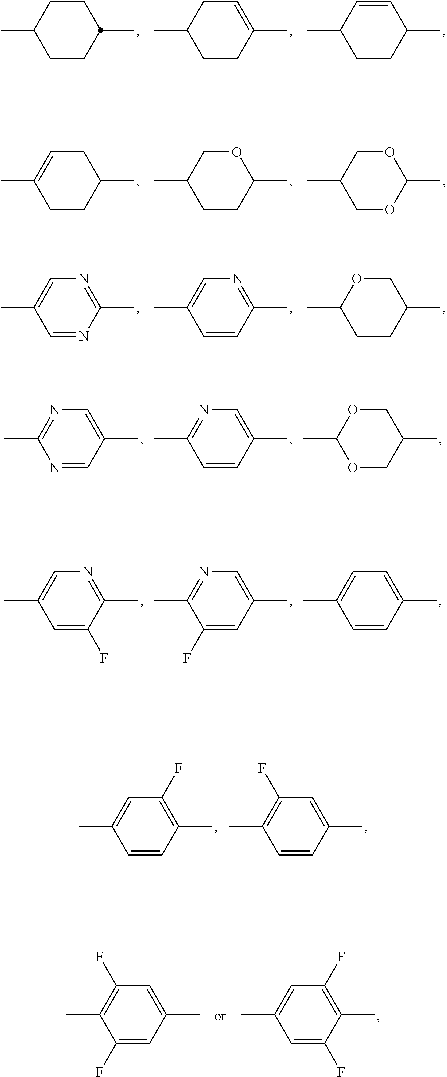

L¹¹ and L¹², independently of one another, denote H or F,
X¹ denotes F, Cl, a halogenated alkyl radical, a halogenated alkenyl radical, a halogenated alkoxy radical or a halogenated alkenyloxy radical having up to 6 C atoms,
Z¹ denotes —CH₂CH₂—, —CF₂CF₂—, —COO—, trans- —CH═CH—, trans- —CF═CF—, —CH₂O— or a single bond,
   with the proviso that the compounds of the formula CC are excluded.

The compounds of the formula I are preferably selected from the compounds of the following sub-formulae:

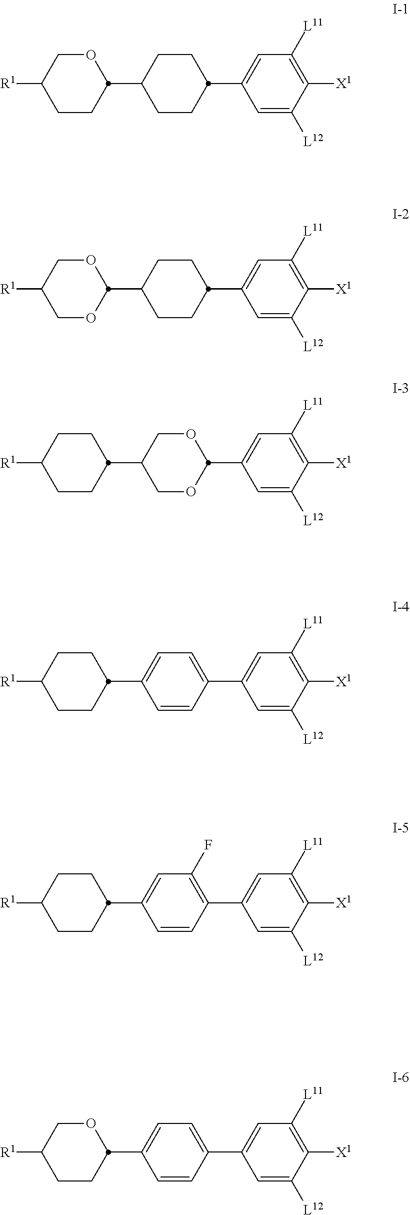

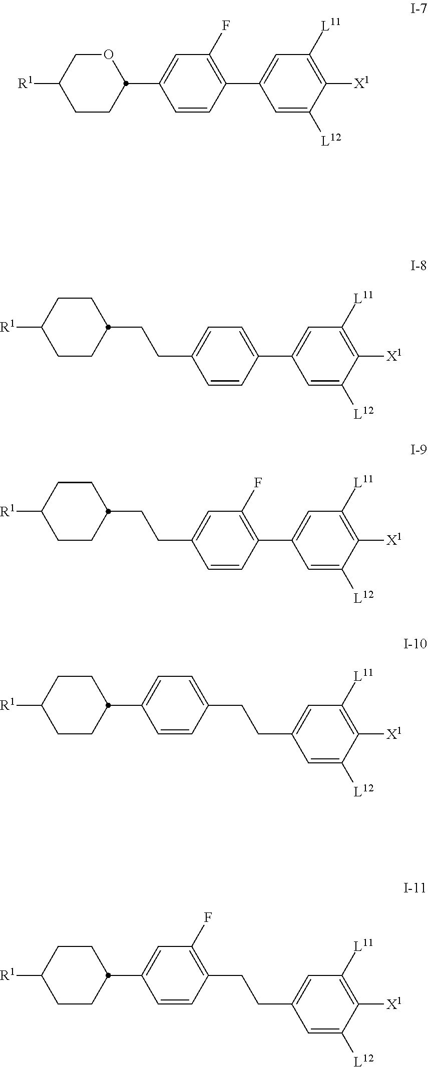

where the groups occurring have the meanings indicated above.

The compounds of the formula I are particularly preferably selected from the group of the compounds I-4 and I-5, very particularly preferably selected from the following sub-formulae:

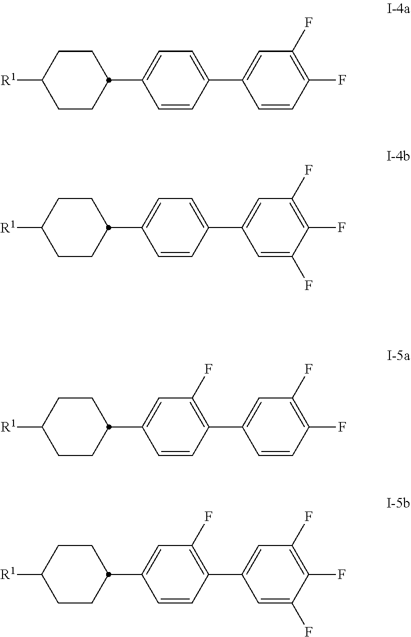

The medium according to the invention preferably additionally comprises one or more compounds of the formula II

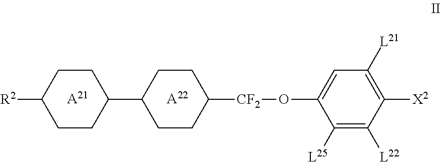

in which
R² denotes an alkyl or alkoxy radical having 1 to 15 C atoms, in which a methylene group may be replaced by

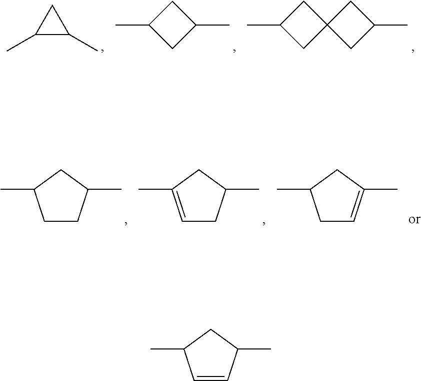

and in which one or more H atoms may by replaced by F,

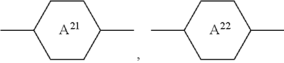

on each occurrence, identically or differently, denote

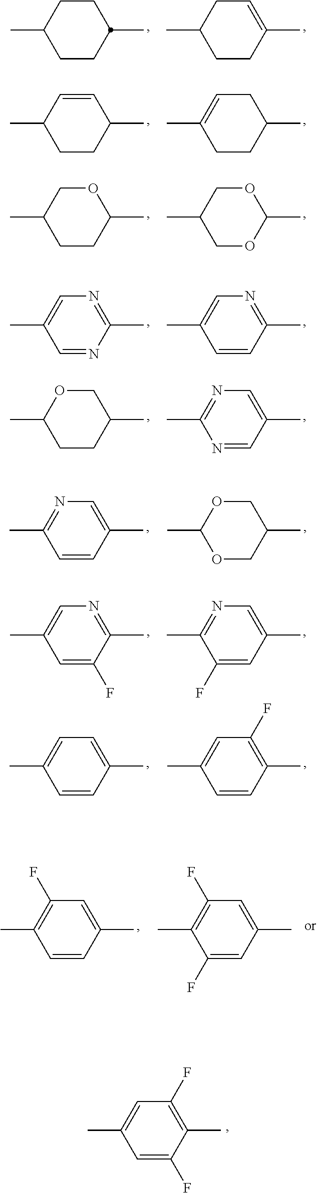

L²¹ and L²², independently of one another, denote H or F,
L²⁵ denotes H or methyl, preferably H,
X² denotes F, Cl, CN, a halogenated alkyl radical, a halogenated alkenyl radical, a halogenated alkoxy radical or a halogenated alkenyloxy radical having 1 to 6 C atoms,
preferably in a total concentration of 40% or less.

The compounds of the formula II are preferably selected from the group of the compounds of the formulae II-1 to II-6

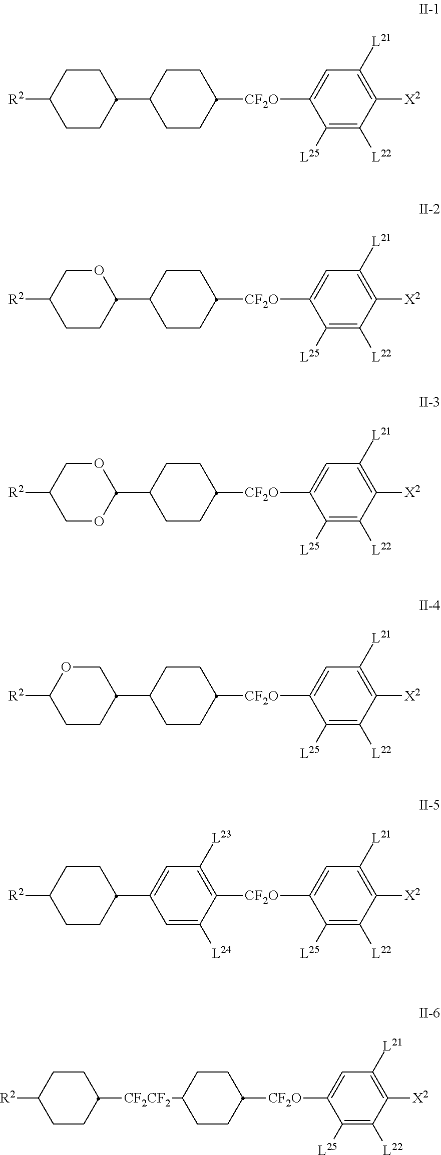

in which
R² denotes n-alkyl having 1 to 7 C atoms, in which a methylene group may be replaced by

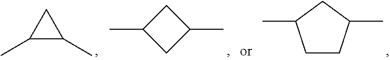

wherein one or more H atoms may be replaced by F,
L²¹, L²²,
L²³ and L²⁴, independently of one another, denote H or F,
L²⁵ H or methyl, preferably H, and
X² denotes F, Cl, halogenated alkyl or halogenated alkoxy having 1 to 6 C atoms.

In a particularly preferred embodiment, the compounds of the formula II are selected from the compounds of the formulae II-1a to II-1e

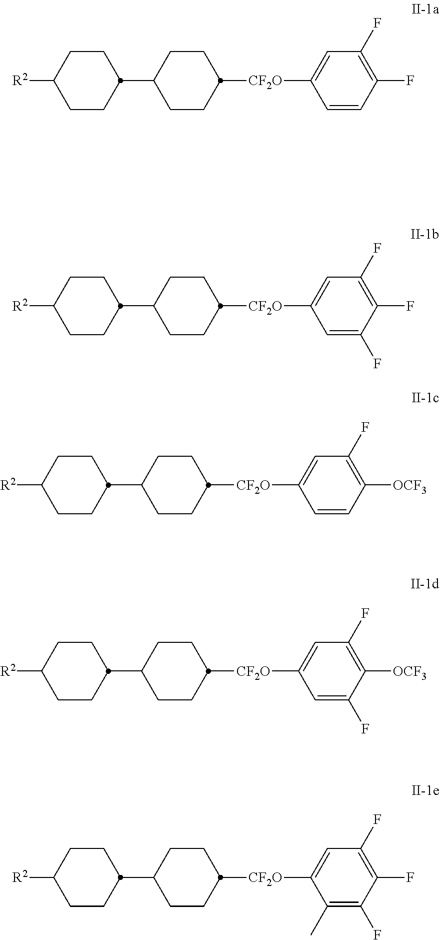

in which R² has the meaning given for formula II-1.

The medium particularly preferably comprises at least one compound of the formula I-1b, preferably selected from the group of compounds of the formulae II-1b-1 bis II-1b-10:

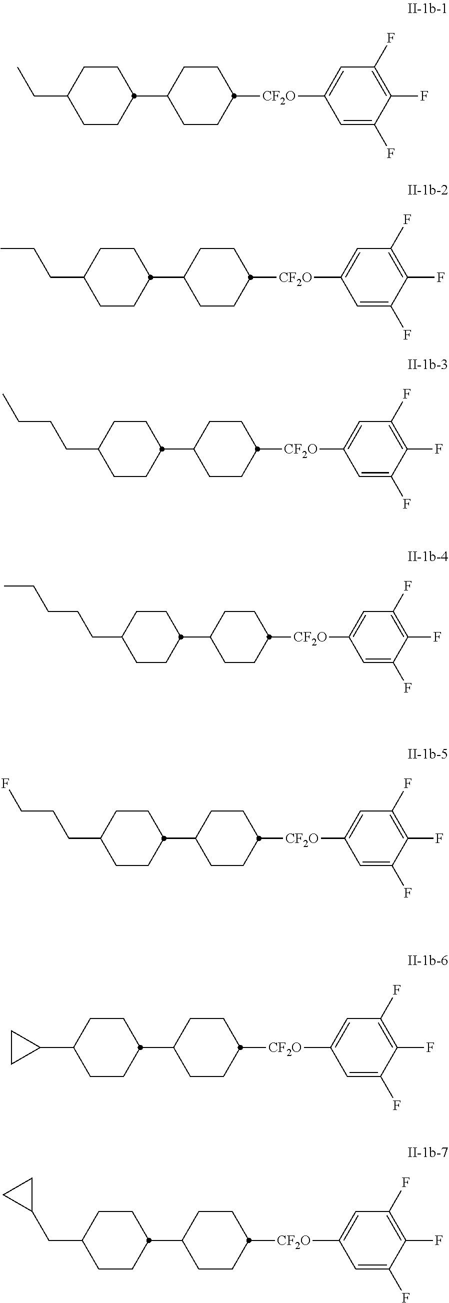

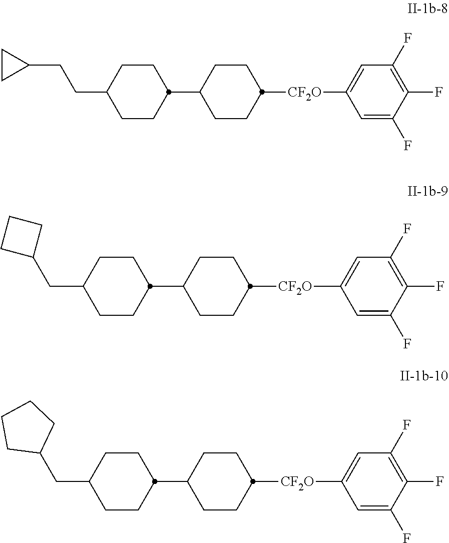

In a further preferred embodiment, the media according to the invention comprise one or more compounds selected from the group of the compounds of the formulae IIA and IIB,

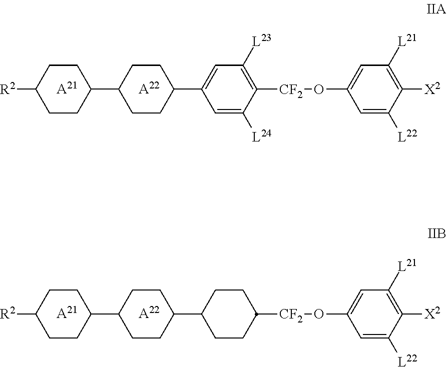

in which the groups occurring have the meaning indicated for formula II and preferably
R² denotes n-alkyl having up to 7 C atoms,
X² denotes F, Cl, halogenated alkyl or halogenated alkoxy having up to 6 C atoms,
L²¹, L²²,
L²³ and L²⁴ each, independently of one another, denote H or F.
X² particularly preferably denotes F, Cl, CF₃, OCF₃ or OCHF₂.

The compounds of the formula IIA are preferably selected from the following sub-formulae IIA-1 to IIA-7, particularly preferably from the compounds of the formula IIA-1,

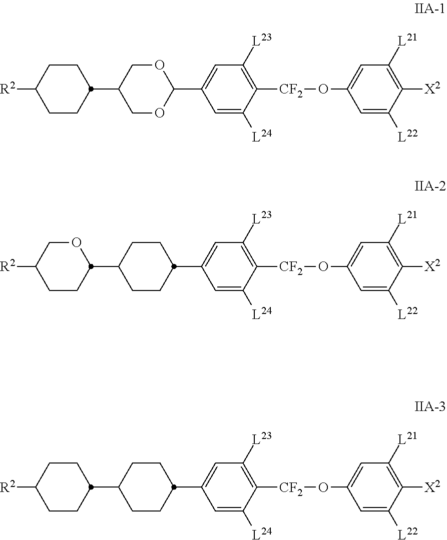

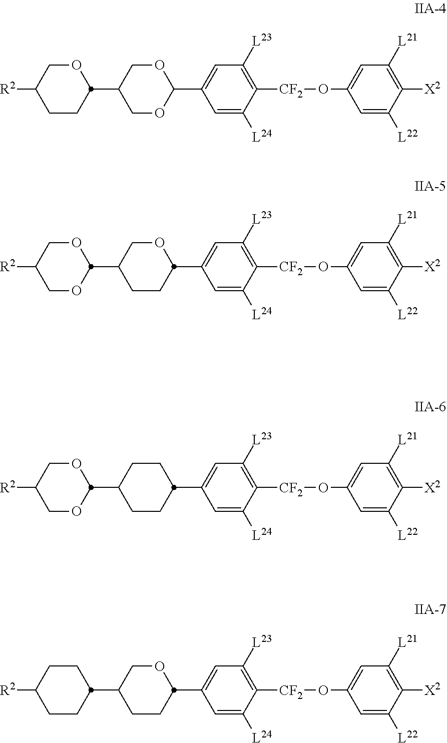

where the groups occurring have the meanings indicated above.

The compounds of the formula IIA are particularly preferably selected from the compounds of the formulae IA-1a to IIA-1d

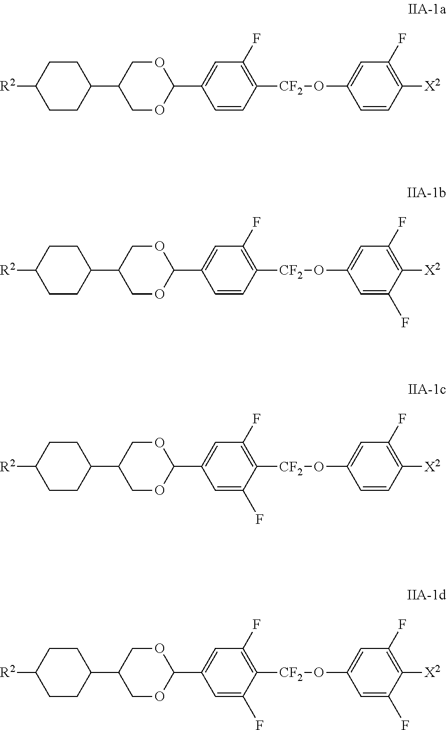

in which R² has the meaning indicated above and X² preferably denotes F or OCF₃.

Very particular preference is given to the compounds of the formula IA-1d.

Particularly preferred compounds of the formula IIB are selected from the compounds of the formula IIB-1

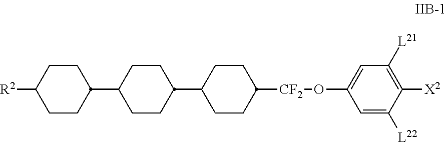

in which the parameters have the meanings indicated above, and preferably at least one of the radicals L²¹ and L²² denotes F and X² denotes F, Cl, CF₃ or OCF₃.

In a preferred embodiment, the medium comprises one or more compounds of the general formula III,

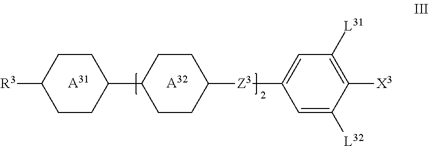

in which
R³ has the meaning indicated for R² above under formula II,

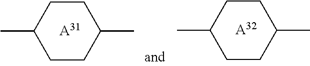

on each occurrence, independently of one another, denote

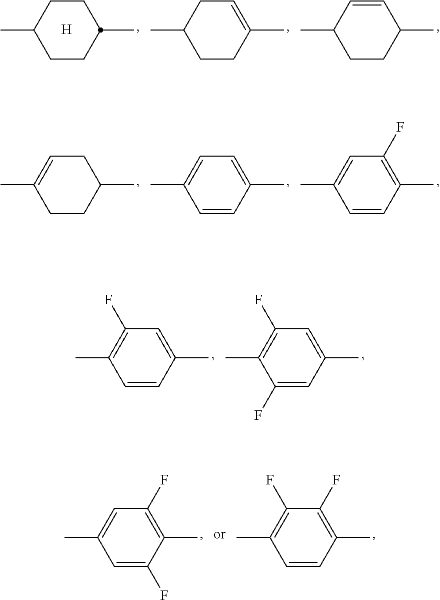

preferably one or more of

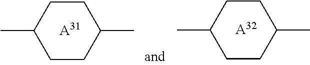

denotes

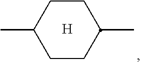

L³¹ and L³², independently of one another, denote H or F,
X³ denotes F, Cl, CN, a halogenated alkyl radical, a halogenated alkenyl radical, a halogenated alkoxy radical or a halogenated alkenyloxy radical having up to 6 C atoms,
Z³ on each occurrence, independently of one another, denotes —CH₂CH₂—, —COO—, trans- —CH═CH—, trans- —CF═CF—, —CH₂O—, —C≡C— or a single bond, preferably one or both denote a single bond.

The compounds of the formula III are preferably selected from the group of the compounds of the formulae III-1 to III-9:

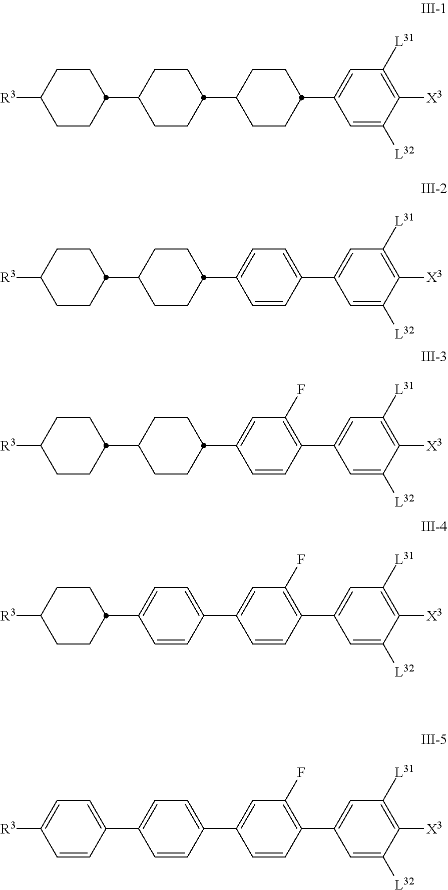

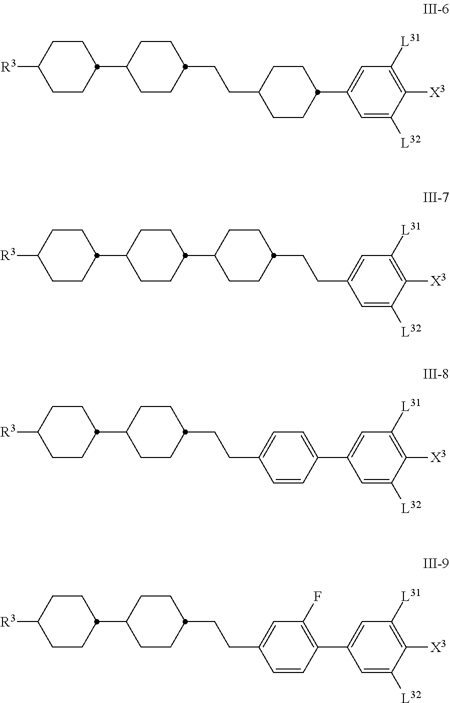

in which
L³¹ and L³², independently of one another, denote H or F,
X³ denotes F, Cl, halogenated alkyl or halogenated alkoxy having up to 6 C atoms and preferably denotes F or OCF₃.

The medium particularly preferably comprises one or more compounds selected from the group of the compounds of the formulae III-1 and III-3.

The medium very particularly preferably comprises one or more compounds of the following sub-formulae:

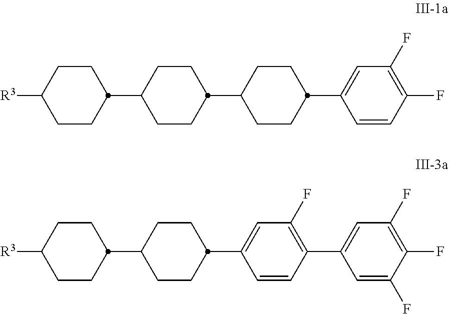

in which R³ preferably denotes n-alkyl having 1 to 7 C atoms.

The medium according to the invention preferably comprises one or more compounds of the formula IV

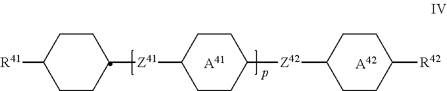

in which
R⁴¹ and R⁴², independently of one another, have the meaning indicated above for R² under formula II, and
   preferably
R⁴¹ denotes alkyl having up to 7 C atoms and
R⁴² denotes alkyl or alkoxy, each having up to 7 C atoms,
   or
R⁴¹ denotes alkenyl having up to 7 C atoms and
R⁴² denotes alkyl oder alkenyl, each having up to 7 C atoms,
   where one or more H atoms in the radicals R⁴¹ and R⁴² may be replaced by F,

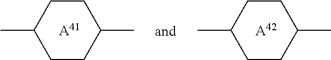

on each occurrence, independently of one another, denote

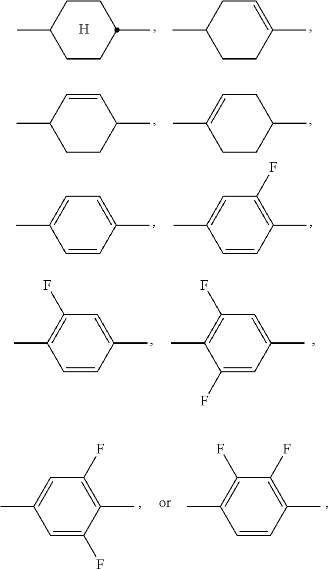

preferably one or more of

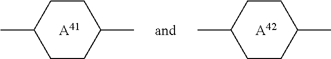

denote(s)

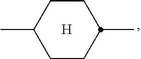

Z⁴¹ and Z⁴² on each occurrence, independently of one another, denote —CH₂CH₂—, —CF₂CF₂—, —CF₂CH₂—, —COO—, trans- —CH═CH—, trans- —CF═CF—, —CH₂O—, —CF₂O—, —C≡C— or a single bond, preferably one or more thereof denote(s) a single bond, and
p denotes 0, 1 or 2, preferably 0 or 1.

The compounds of the formula IV are preferably selected from the group of the compounds of the formulae IV-1 to IV-13

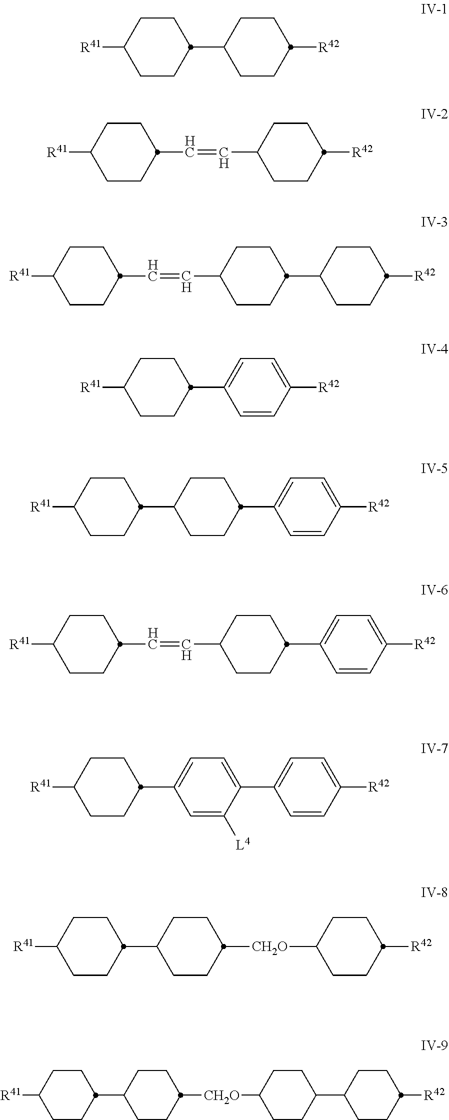

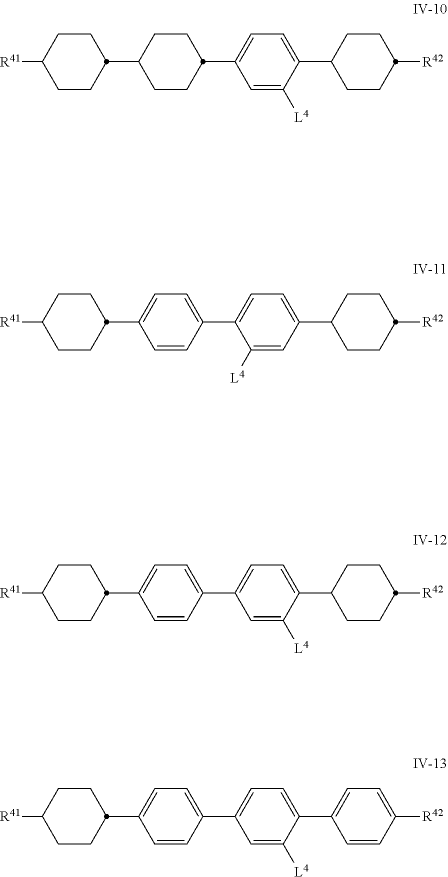

in which R⁴¹ and R⁴² have the meanings indicated above and L⁴ denotes H or F and preferably
R⁴¹ and R⁴², independently of one another, denote n-alkyl having 1 to 7 C atoms, and
L⁴ denotes F.

The medium according to the invention particularly preferably comprises one or more compounds selected from the group of the compounds of the formulae IV-5, IV-8 and IV-11.

In a further preferred embodiment, the medium according to the invention comprises one or more compounds of the formula V

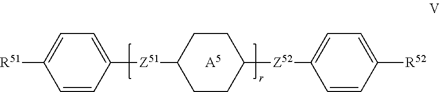

in which
R⁵¹ and R⁵², independently of one another, have the meaning indicated above for R² under formula II, preferably R⁶¹ denotes alkyl and R⁶² denotes alkyl or alkenyl,

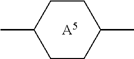

on each occurrence, independently of one another, denotes

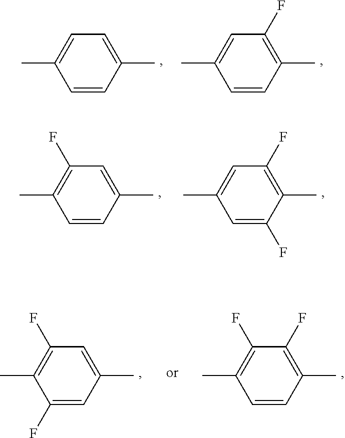

preferably one or more of

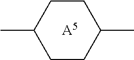

denotes,

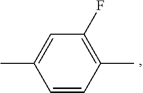

Z⁵¹ and Z⁵², independently of one another and, if Z⁵¹ occurs twice, also these independently of one another, denote —CH₂CH₂—, —COO—, trans- —CH═CH—, trans- —CF═CF—, —CH₂O— or a single bond, preferably one or more thereof denote(s) a single bond, and
r denotes 0, 1 or 2, preferably 1 or 2, particularly preferably 1.

In a further preferred embodiment, the medium comprises one or more compounds selected from the group of the compounds of the formulae V-1 and V-2,

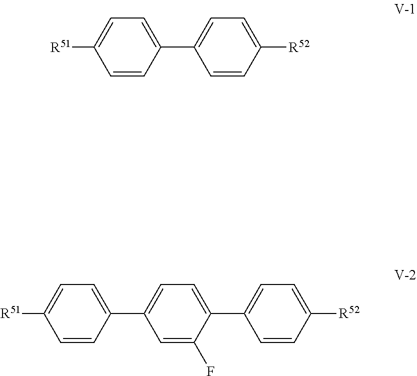

in which R⁵¹ and R⁵² have the respective meanings indicated above under formula V and preferably denote alkyl.

The compounds of the formulae CC and I to IV are prepared by methods known per se, as described in the literature (for example in the standard works, such as Houben-Weyl, Methoden der Organischen Chemie [Methods of Organic Chemistry], Georg-Thieme-Verlag, Stuttgart), to be precise under reaction conditions which are known and suitable for the said reactions. Use can also be made here of variants known per se which are not mentioned in greater detail here. The compounds of the formulae II and IIA are known, for example, from DE 10 2008 062858 A1. The compounds of the formula IIB are disclosed in DE 102223061 A1.

The liquid-crystal mixtures according to the invention enable a significant broadening of the available parameter latitude. The achievable combinations of clearing point, phase width, viscosity at low temperature, thermal and UV stability and dielectric anisotropy are far superior to previous materials from the prior art.

The invention furthermore also relates to electro-optical components, in particular light valves, based on the VA, IPS, FFS, TN or STN effect, having two plane-parallel outer plates, which, with a frame, form a cell, integrated non-linear elements for switching individual pixels on the outer plates, and a nematic liquid-crystal mixture having positive dielectric anisotropy and high specific resistance located in the cell, which contain the media according to the invention, and to the use of these media for electro-optical purposes.

The invention furthermore relates to the use of the electro-optical media or components in lighting devices for vehicles and in liquid-crystal displays, in particular TN, STN or MLC displays.

The invention furthermore relates to lighting devices for vehicles and to electro-optical displays which contain these components.

A vehicle lighting device according to the invention has at least one light source. This light source emits light, so that furthermore at least one screen device for influencing the light emitted by the light source is provided. The screen device is in the form of an LCD screen and accordingly has at least one liquid-crystal light valve, which can be transilluminated from the back.

In a lighting device according to the invention, the light source can have a very wide variety of designs. It can have one or more lamps. Suitable lamps are, for example, conventional lamps in the form of incandescent bulbs or gas-discharge lamps. For the purposes of the present invention, modern lamps, for example LEDs, are also conceivable as lamps for the light source, as are, in particular, also the cold cathode lamps (CCFLs) used for liquid-crystal displays. The individual lamps can be arranged differently, for example in a matrix-like manner. One or more arrangements of further optical components in the light source or in the lighting device may of course bring advantages. These can be, for example, one or more reflectors or one or more lenses.

It is likewise advantageous if the liquid-crystal light valve in a lighting device according to the invention has a first polariser, through which the light provided by the light source ingresses. Furthermore, a second polariser is provided, through which the light leaves the liquid-crystal light valve. A layer comprising the liquid-crystal medium according to the invention is arranged between the first polariser and the second polariser. This liquid-crystal layer serves to rotate the plane of polarisation of the light passing through this liquid-crystal layer as a function of an applied voltage. Depending on the type of design of the liquid-crystal layer, this liquid-crystal layer may effect rotation of the polarisation of the light in the electric field or prevent this rotation function of the light passing through. In an embodiment of this type, the liquid-crystal light valve and in particular the first polariser are designed to be temperature-resistant up to about 200° C. This is important, in particular, in the case of the first polariser, since this absorbs up to about 50% of the light emitted by the light source and the associated energy. The various designs of the polarisers in connection with the alignment of the liquid-crystal molecules in the liquid-crystal layer essentially correspond to those that are used in liquid-crystal displays and are known to the person skilled in the art. In principle, all known configurations are suitable, and preference is given to liquid-crystal light valves of the TN, STN, VA, IPS or FFS type, particularly preferably of the TN or STN type.

It goes without saying that, through a suitable choice of the components of the mixtures according to the invention, it is also possible for higher clearing points (for example above 150° C.) to be achieved at higher threshold voltages or lower clearing points to be achieved at lower threshold voltages with retention of the other advantageous properties. At viscosities correspondingly increased only slightly, it is likewise possible to obtain mixtures having greater Δε and thus low thresholds. The electro-optical components according to the invention preferably operate at the first Gooch and Tarry transmission minimum [C. H. Gooch and H. A. Tarry, Electron. Lett. 10, 2-4, 1974; C. H. Gooch and H. A. Tarry, Appl. Phys., Vol. 8, 1575-1584, 1975], where, besides particularly favourable electro-optical properties, such as, for example, high steepness of the characteristic line and low angle dependence of the contrast (German Patent 30 22 818), a lower dielectric anisotropy is sufficient at the same threshold voltage as in an analogous display at the second minimum. This enables significantly higher specific resistance values to be achieved using the mixtures according to the invention at the first minimum than in the case of mixtures comprising cyano compounds. Through a suitable choice of the individual components and their proportions by weight, the person skilled in the art is able to set the birefringence necessary for a pre-specified layer thickness of the component using simple routine methods.

Measurements of the voltage holding ratio (HR) [S. Matsumoto et al., Liquid Crystals 5, 1320 (1989); K. Niwa et al., Proc. SID Conference, San Francisco, June 1984, p. 304 (1984); G. Weber et al., Liquid Crystals 5, 1381 (1989)] have shown that mixtures according to the invention comprising compounds of the formula CC exhibit a significantly smaller decrease in the HR with increasing temperature than analogous mixtures comprising cyanophenylcyclohexanes of the formula

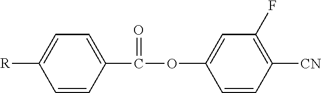

or esters of the formula

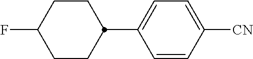

instead of the compounds of the formula CC.

The UV stability of the mixtures according to the invention is also considerably better, i.e. they exhibit a significantly smaller decrease in the HR on exposure to UV.

The liquid-crystal mixtures according to the invention, while retaining the nematic phase down to −20° C. and preferably down to −30° C., particularly preferably down to −40° C., enable a clearing point of 120° C. or more, at the same time dielectric anisotropy values Δε≥4, preferably ≥8, and a high value for the specific resistance to be achieved, enabling excellent light valves according to the invention to be obtained. In particular, the mixtures are characterised by low operating voltages. The TN thresholds are below 2.0 V, preferable below 1.5 V, particularly preferably <1.3 V.

The clearing point of the liquid-crystal mixtures according to the invention is preferably 125° C. or more, preferably 130° C. or more, particularly preferably 135° C. or more, very particularly preferably 140° C. or more and in particular 145° C. or more.

The liquid-crystal mixtures according to the invention have an optical anisotropy (Δn) in the range from 0.050 to 0.110, preferably from 0.060 to 0.100, particularly preferably from 0.080 to 0.090 and very particularly preferably from 0.070 to 0.085.

The rotational viscosity γ₁ of the mixtures according to the invention at 20° C. is preferably <350 mPa·s, particularly preferably <300 mPa·s. The nematic phase range is preferably at least 140 K, in particular at least 180 K. This range preferably extends at least from −40° to +140°.

Further embodiments of the present invention which are preferred both alone and also in combination with one another are indicated below (the meaning of the acronyms used below can be taken from Tables A to D shown below):
The total concentration of the compounds of the formula CC in the medium is 35% or more, preferably 45% or more, particularly preferably 50% or more, very particularly preferably 55% or more and in particular 60% or more.
The total concentration of the compounds of the formulae CC and I in the medium is 35% or more, preferably 45% or more, particularly preferably 50% or more, very particularly preferably 55% or more.
The medium comprises one or more compounds of the formula CC in a total concentration in the range from 34% to 100%, preferably from 40% to 95%, particularly preferably from 45% to 75%.
The medium comprises one or more compounds of the formulae CC and I in a total concentration in the range from 34% to 100%, preferably from 40% to 95%, particularly preferably from 45% to 75%.
The total concentration of compounds of the formula II in the medium is 40% or less, preferably 37% or less, particularly preferably 33% or less and very particularly preferably 30% or less, in particular 25% or less.
The total concentration of compounds of the formula II in the medium is, if present, 2% to 35%, preferably 5% to 30% and particularly preferably 10% to 25%.
The total concentration of the compounds of the formulae CC and II in the medium is 35% to 100%, preferably 60% to 90%, particularly preferably 62 to 85% and very particularly preferably 65% to 80%.
The total concentration of the compounds of the formulae IV-1, IV-2, IV-3, IV-4, IV-5, IV-6 and IV-7 in the medium is 3 to 25%, preferably 5 to 18%, particularly preferably 8% to 16%. The medium preferably comprises at least one compound of the formula IV-5.
The medium comprises one, two, three or more compounds of the formula IV-1 in a total concentration of 0 to 25%, preferably 0.5 to 15%, particularly preferably 1 to 10% and very particularly preferably 2 to 5%.
The medium comprises one, two, three or more compounds of the formula IV-1 in a total concentration of 25% or less.
The total concentration of compounds of the formulae IV-7, IV-8, IV-9, IV-10, IV-11, IV-12 and IV-13 is 2% to 20%, preferably 4% to 16% and particularly preferably 6% to 13%. The medium preferably comprises at least one compound of the formula IV-8 or IV-11, particularly preferably IV-11.
The medium comprises one or more compounds of the formula IA and/or IB and one or more compounds of the formula IV-11.
The medium comprises one or more compounds selected from the group of the compounds IIA, IIB and III, preferably selected from CCGU-n-F, CCPU-n-F, CCCG-n-F, CCCQU-n-F, CCCQU-n-OT and CDUQU-n-F in a total concentration of 3% to 15%, preferably 5% to 13%, particularly preferably 7% to 10%.
The medium comprises one, two, three or more compounds CCU-n-O1D preferably in a total concentration of 20% to 60%, particularly preferably from 25% to 50% and very particularly preferably from 30% to 40%
and/or
one, two, three or more compounds CCU-n-OD, preferably in a total concentration of 30% to 65%, particularly preferably from 40% to 60% and very particularly preferably from 45% to 55%.
The medium comprises one, two, three, four or more compounds CCG-n-F, preferably in a total concentration of 20% to 70%, particularly preferably from 40% to 65% and very particularly preferably from 45% to 55%.
The medium comprises one, two, three or more compounds CCU-n-F, preferably in a total concentration of 5% to 60%, particularly preferably from 10% to 45% and very particularly preferably from 20% to 30%.
The medium comprises three or more compounds CCG-n-F and three or more compounds of the formula CCU-n-F.
The medium comprises the compound CCG-1-F.
The medium comprises one, two, three or more compounds CCP-n-Cl, preferably in a total concentration in the range from 30 to 70%, particularly preferably from 40 to 60% and very particularly preferably from 45 to 55%.
The medium comprises two, three or more compounds CCEG-n-F and three or more compounds of the formula CCP-n-Cl.
The medium comprises one, two, three, four or more compounds CCEG-n-F.
The medium comprises three or more compounds CCEG-n-F and three or more compounds of the formula CCU-n-F.
The medium comprises the compound CCEG-1-F.
The medium comprises two, three or more compounds CCEG-n-F and three or more compounds of the formula CCP-n-Cl.
The medium comprises two, three or more compounds CCEP-n-F, preferably in a total concentration of 20% to 60%, particularly preferably from 30% to 50% and very particularly preferably from 35% to 45%.
The medium comprises CCEP-1-F, preferably in a concentration of 15% to 35%, particularly preferably from 20% to 30%, very particularly preferably from 23% to 27%.
The medium comprises two, three or more compounds CCEU-n-F and two, three or more compounds selected from CCEP-n-F and CCEG-n-F.
The proportion of the compounds containing unsaturated side chains (R denotes alkenyl or alkynyl) in the medium is 0 to 10%, preferably 0.5 to 5%, particularly preferably 1 to 2%.

The total concentration of the compounds present in the medium is 100%. The concentration of the compounds mentioned in the medium is 100% or less.

It has been found that the liquid-crystal mixtures according to the invention using one or more compounds selected from the compounds of the formulae CC, I, II, IIA, IIB and III to V result in lower values for the birefringence compared with the prior art, with at the same time broad nematic phases, very high clearing points and low smectic-nematic transition temperatures being observed, causing an improvement in the storage stability. Particular preference is given to mixtures which, besides one or more compounds of the formulae CC, I and II, comprise one or more compounds of the formula II-A and/or IIB and/or III and/or IV. All the said compounds are colourless, stable and readily miscible with one another and with other liquid-crystal materials.

The optimum mixing ratio of the compounds of the formulae CC, I, II, IIA, IIB and III to V depends substantially on the desired properties, on the choice of the components of the formulae CC, I, II, IIA, IIB and III to V and on the choice of any other components that may be present. Suitable mixing ratios within the range given above can easily be determined from case to case.

The total amount of compounds of the formulae CC, I, II, IIA, IIB and III to V in the mixtures according to the invention is not crucial. The mixtures can therefore comprise one or more further components for the purposes of optimisation of various properties. However, the observed effect on the addressing times and the threshold voltage is generally greater, the higher the total concentration of compounds of the formulae CC, I, IIA, IIB, and III. Furthermore, the clearing point is higher, the greater the proportion of compounds of the formulae IIA, IIB, III and IV

The construction of the light valves according to the invention from polarisers, electrode base plates and surface-treated electrodes corresponds to the usual design of components of this type. The term “usual design” is broadly drawn here and also encompasses all derivatives and modifications of the components, in particular also matrix display elements based on poly-Si TFTs or MIMs.

However, a significant difference between the liquid-crystal light valves according to the invention and the hitherto conventional displays based on the twisted nematic cell consists in the choice of the liquid-crystal parameters of the liquid-crystal layer.

The liquid-crystal mixtures which can be used in accordance with the invention are prepared in a manner conventional per se. In general, the desired amount of the components used in the lesser amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing.

The dielectrics may also comprise further additives known to the person skilled in the art and described in the literature. For example, 0-15% of pleochroic dyes or chiral dopants can be added.

C denotes a crystalline phase, S a smectic phase, Sc a smectic C phase, N a nematic phase and I the isotropic phase.

V₁₀ denotes the voltage for 10% transmission (viewing direction perpendicular to the plate surface). tₒₙ denotes the switch-on time and t_{off} the switch-off time at an operating voltage corresponding to 2.0 times the value of V₁₀. Δn denotes the optical anisotropy and nₒ denotes the refractive index. Δε denotes the dielectric anisotropy (Δε=ε_{∥}−ε_{⊥}, where ε_{∥} denotes the dielectric constant parallel to the longitudinal molecular axes and ε_{⊥} denotes the dielectric constant perpendicular thereto). The electro-optical data were measured in a TN cell at the 1st minimum (i.e. at a d·Δn value of 0.5) at 20° C., unless expressly stated otherwise. The optical data were measured at 20° C., unless expressly indicated otherwise.

For the present invention and in the following examples, the structures of the liquid-crystal compounds are indicated by means of acronyms, with the transformation into chemical formulae taking place in accordance with Tables A to C below. All radicals CₙH₂ₙ₊₁, CₘH₂ₘ₊₁ and CₗH₂ₗ₊₁ or CₙH₂ₙ, CₘH₂ₘ and CₗH₂ₗ are straight-chain alkyl radicals or alkylene radicals, in each case having n, m and I C atoms respectively. Table A shows the codes for the ring elements of the nuclei of the compound, Table B lists the bridging units, and Table C lists the meanings of the symbols for the left- and right-hand end groups of the molecules. The acronyms are composed of the codes for the ring elements with optional linking groups, followed by a first hyphen and the codes for the left-hand end group, and a second hyphen and the codes for the right-hand end group. Table D shows illustrative structures of compounds together with their respective abbreviations.

TABLE A
Ring elements

| | | | |
|---|---|---|---|
| C | 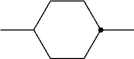 | | |
| D | 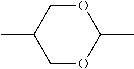 | DI | 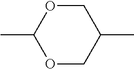 |
| A | 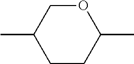 | AI | 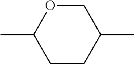 |
| P | 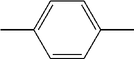 | | |
| G | 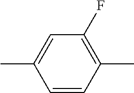 | GI | 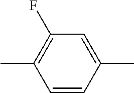 |
| U | 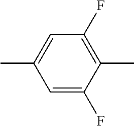 | UI | 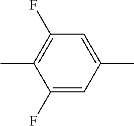 |
| Y | 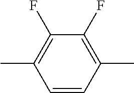 | | |
| P(F, Cl)Y | 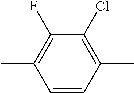 | P(Cl,F)Y | 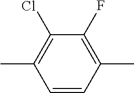 |
| np | 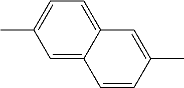 | | |
| n3f | 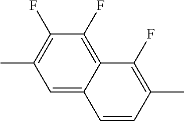 | nN3fI | 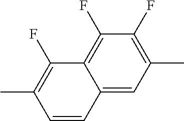 |
| th | 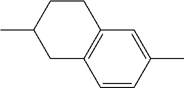 | thI | 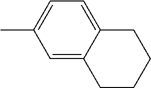 |
| tH2f | 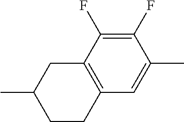 | tH2fI | 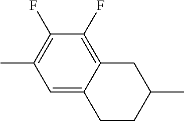 |
| o2f | 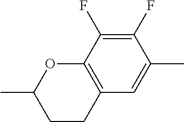 | o2fI | 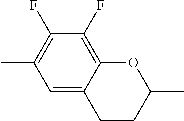 |
| dh | 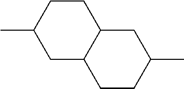 | | |
| K | 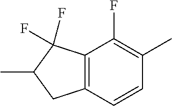 | KI | 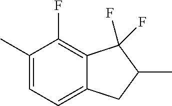 |
| L | 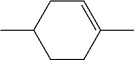 | LI | 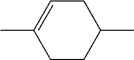 |
| F | 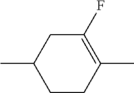 | FI | 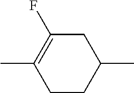 |

TABLE B
Bridging members

| | | | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| O | —CH₂—O— | OI | —O—CH₂— |
| Q | —CF₂—O— | QI | —O—CF₂— |

TABLE C
End groups

| On the left individually | | On the right individually | |
|---|---|---|---|
| or in combination | | or in combination | |
| -n- | CₙH₂ₙ₊₁— | -n- | —CₙH₂ₙ₊₁ |
| -nO- | CₙH₂ₙ₊₁—O— | -nO | —O— CₙH₂ₙ₊₁ |
| —V— | CH₂═CH— | —V | —CH═CH₂ |
| -nV- | CₙH₂ₙ₊₁—CH═CH— | -nV | —CₙH₂ₙ—CH═CH₂ |
| -Vn- | CH₂═CH— CₙH₂ₙ— | -Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| —N— | N≡C— | —N | —C≡N |
| —S— | S═C═N— | —S | —N═C═S |
| —F— | F— | —F | —F |
| —CL— | Cl— | —CL | —Cl |
| —M— | CFH₂— | —M | —CFH₂ |
| —D— | CF₂H— | —D | —CF₂H |
| —T— | CF₃— | —T | —CF₃ |
| —MO— | CFH₂O— | —OM | —OCFH₂ |
| —DO— | CF₂HO— | —OD | —OCF₂H |
| —TO— | CF₃O— | —OT | —OCF₃ |
| —A— | H—C≡C— | —A | —C≡C—H |
| -nA- | CₙH₂ₙ₊₁—CEC— | -An | —C≡C—CₙH₂ₙ₊₁ |
| —NA— | N≡C—C≡C— | —AN | —C≡C—C≡N |
| On the left only in combination | | On the right only in combination | |
| - . . . n . . . - | —CₙH₂ₙ— | - . . . n . . . | —CₙH₂ₙ— |
| - . . . M . . . - | —CFH— | - . . . M . . . | —CFH— |
| - . . . D . . . - | —CF₂— | - . . . D . . . | —CF₂— |
| - . . . V . . . - | —CH═CH— | - . . . V . . . | —CH═CH— |
| - . . . Z . . . - | —CO—O— | - . . . Z . . . | —CO—O— |
| - . . . ZI . . . - | —O—CO— | - . . . ZI . . . | —O—CO— |
| - . . . K . . . - | —CO— | - . . . K . . . | —CO— |
| - . . . W . . . - | —CF═CF— | - . . . W . . . | —CF═CF— |

in which n and m are each integers, and the three dots “ . . . ” are placeholders for other abbreviations from this table.

Besides the compounds of the formula CC, the mixtures according to the invention preferably comprise one or more compounds of the compounds mentioned below.

The following abbreviations are used:

(n, m and z are, independently of one another, each an integer, preferably 1 to 6)

TABLE D

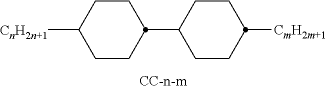

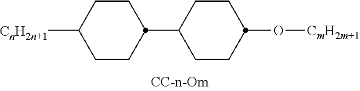

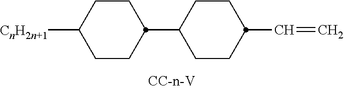

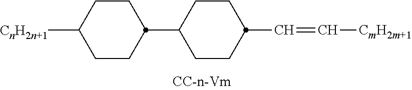

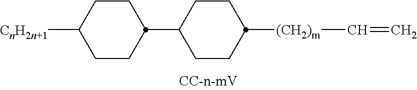

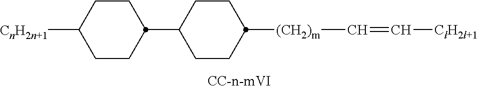

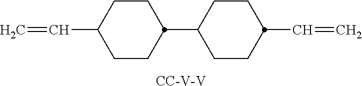

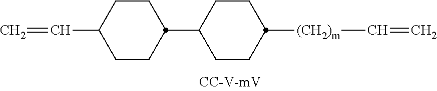

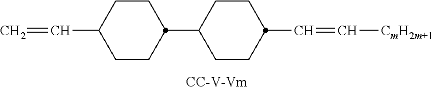

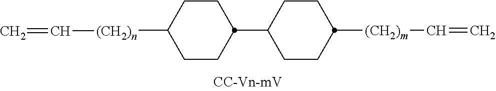

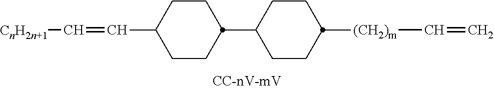

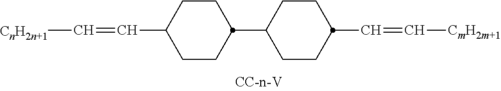

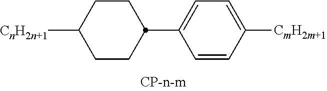

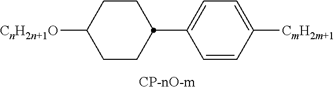

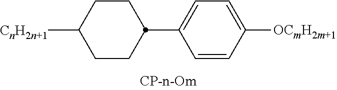

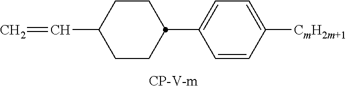

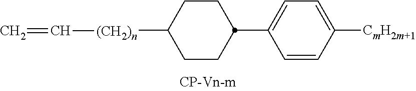

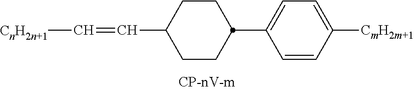

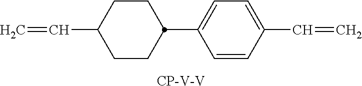

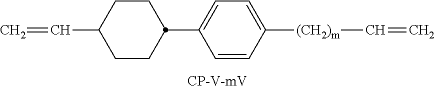

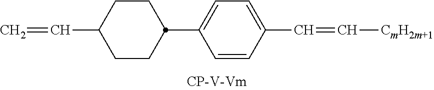

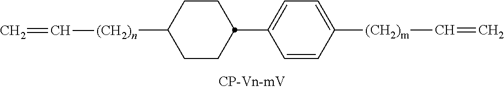

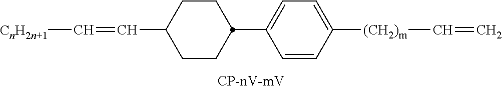

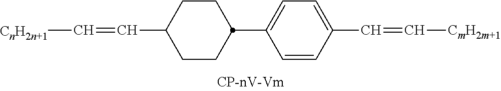

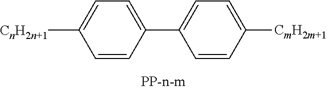

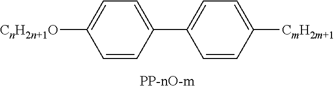

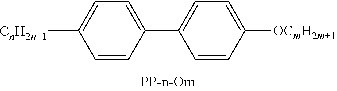

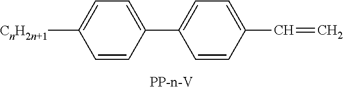

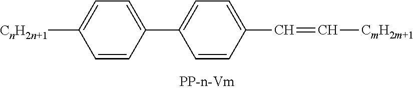

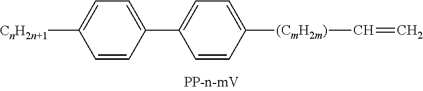

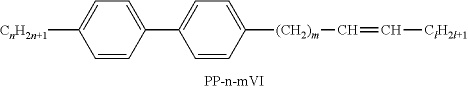

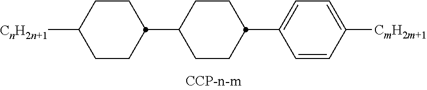

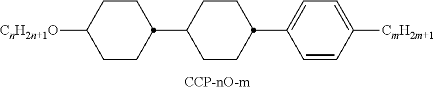

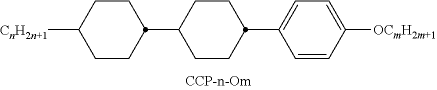

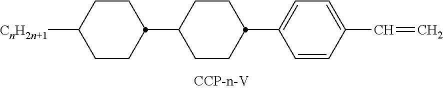

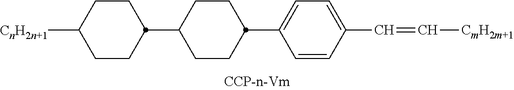

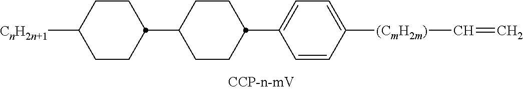

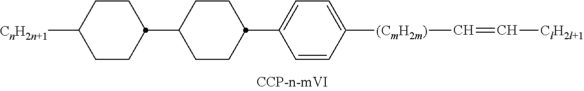

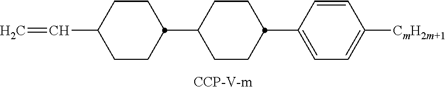

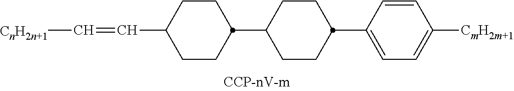

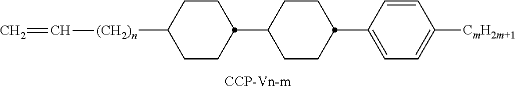

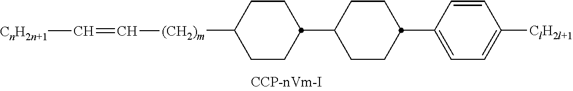

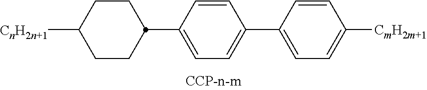

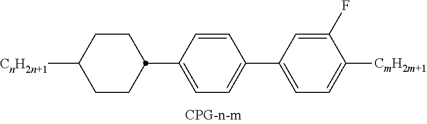

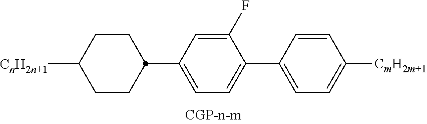

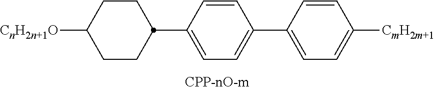

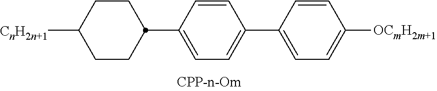

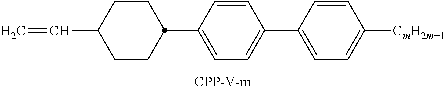

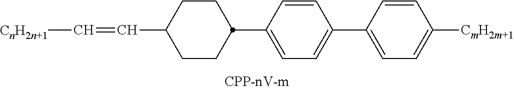

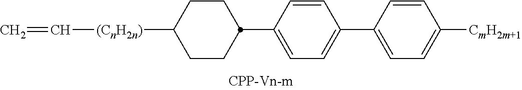

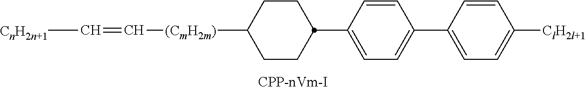

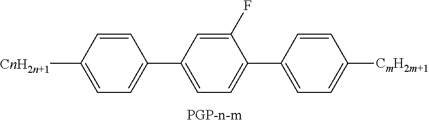

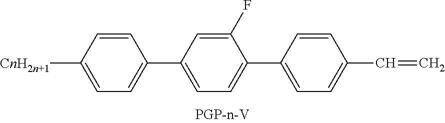

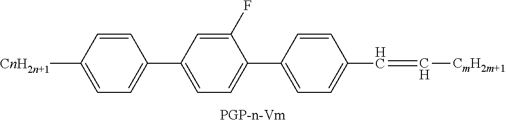

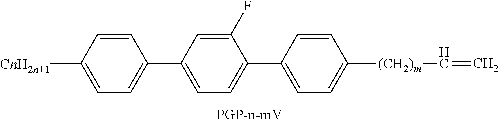

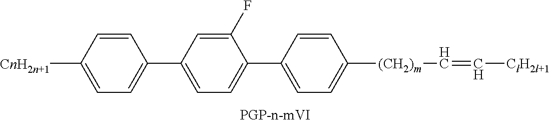

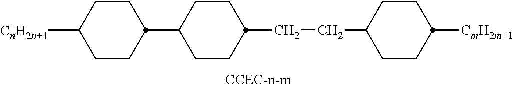

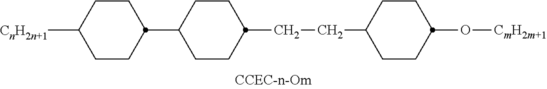

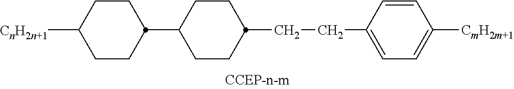

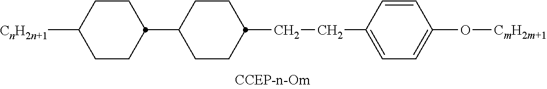

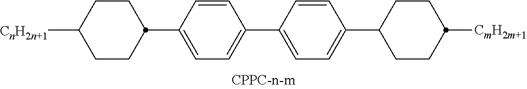

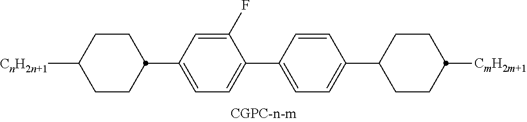

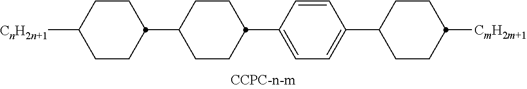

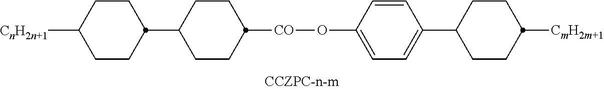

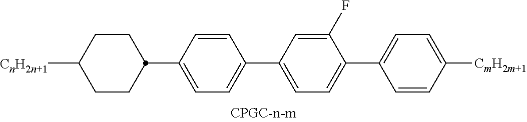

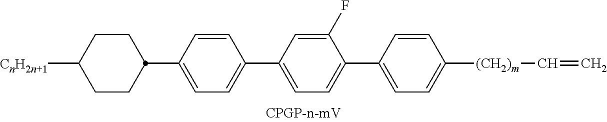

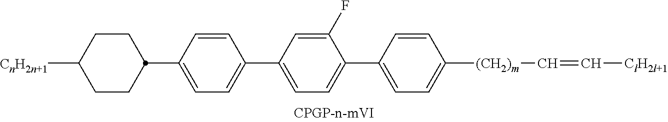

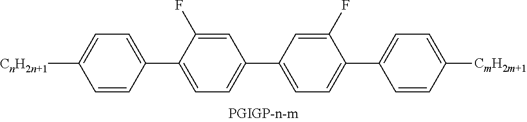

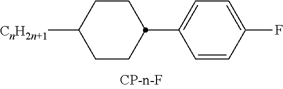

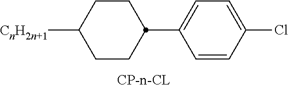

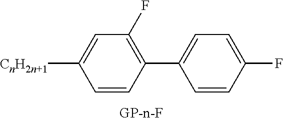

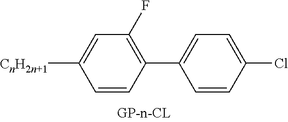

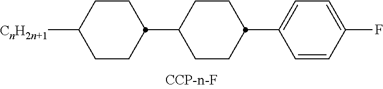

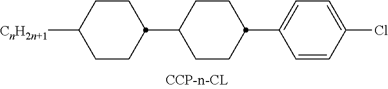

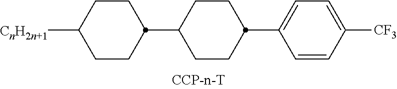

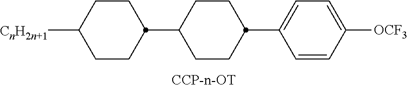

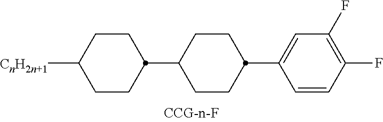

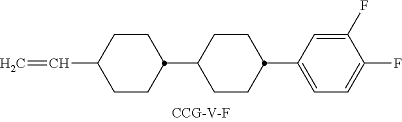

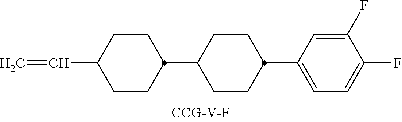

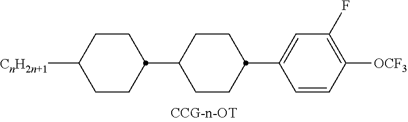

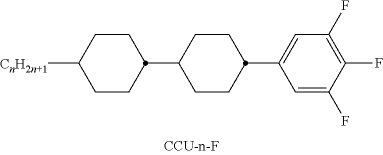

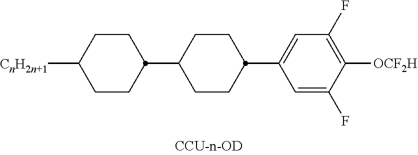

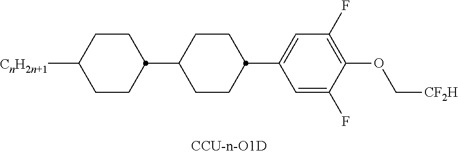

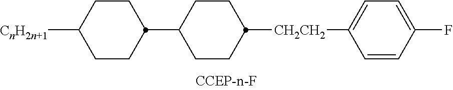

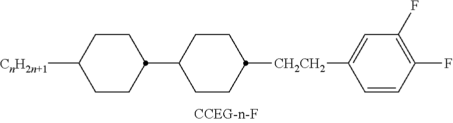

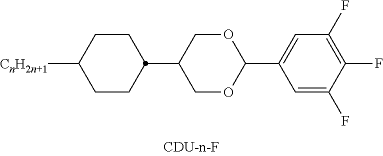

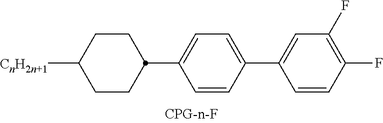

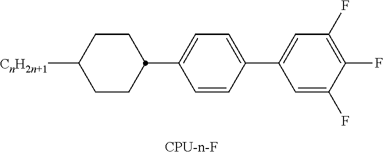

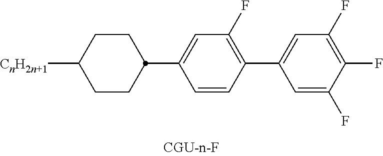

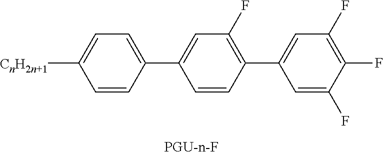

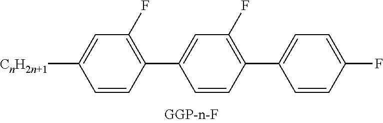

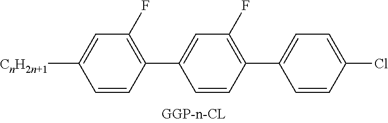

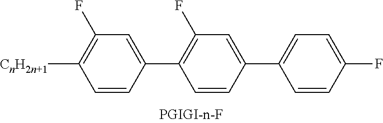

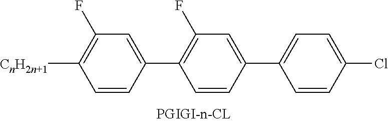

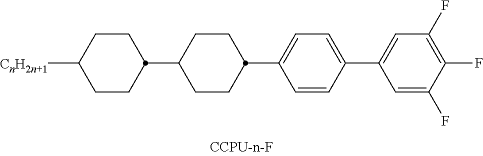

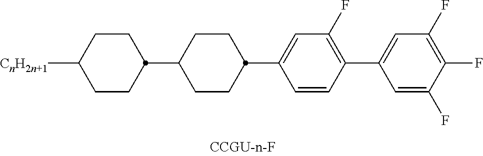

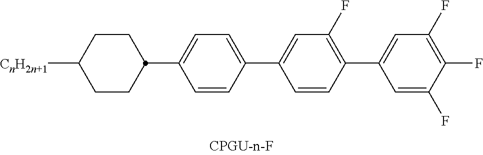

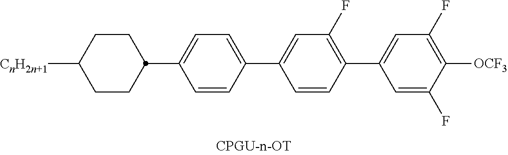

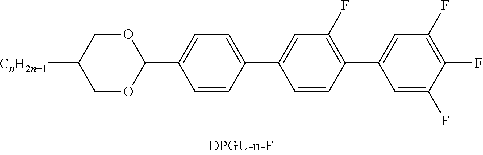

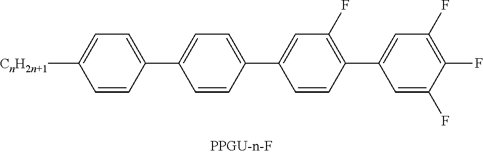

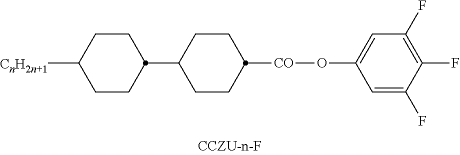

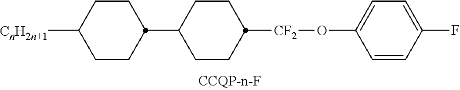

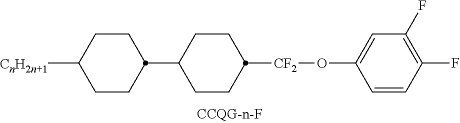

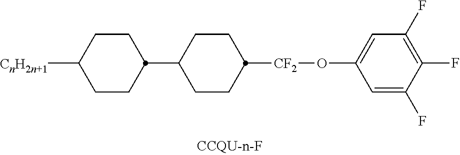

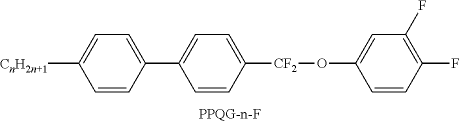

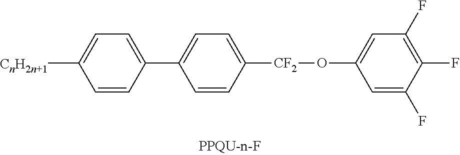

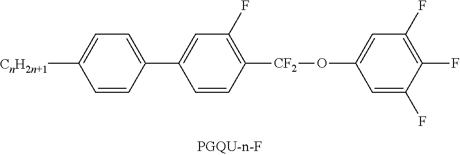

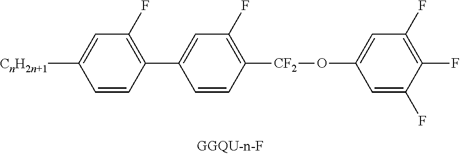

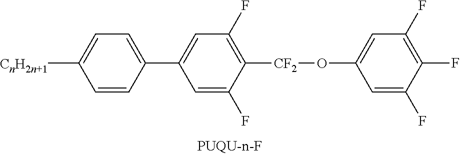

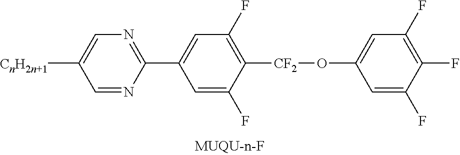

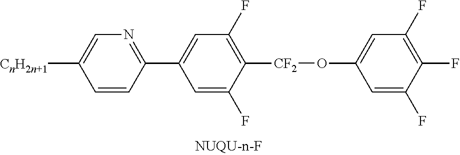

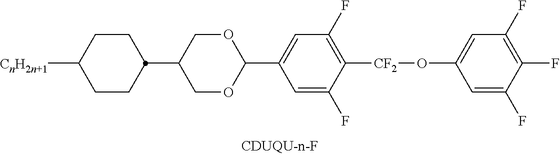

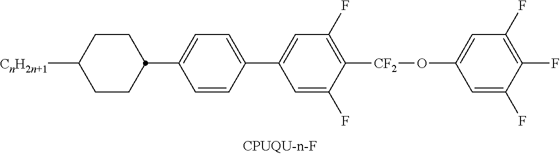

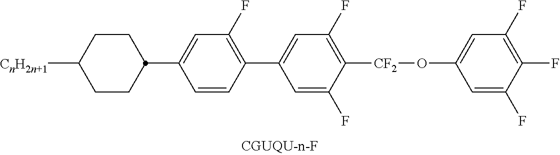

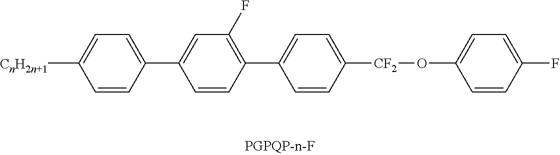

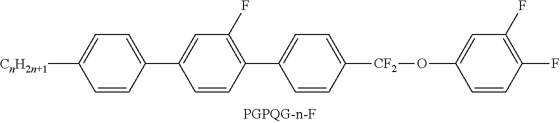

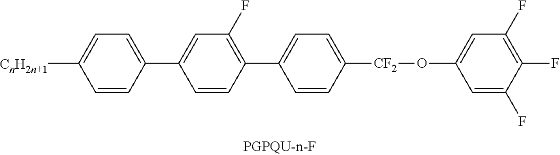

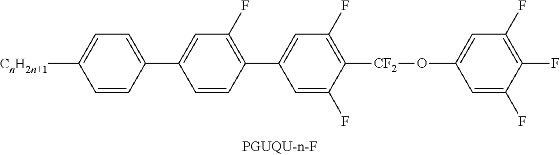

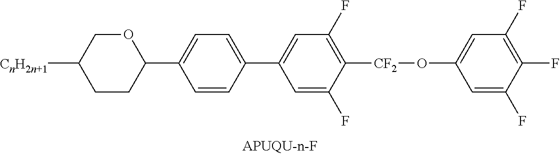

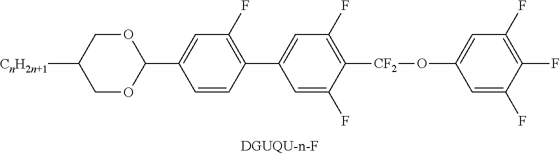

Table E shows chiral dopants which are preferably employed in the mixtures according to the invention.

TABLE E

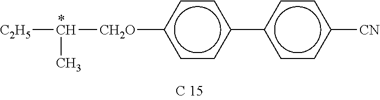

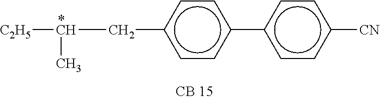

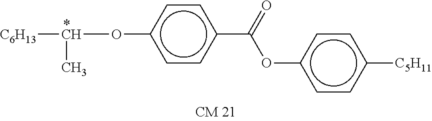

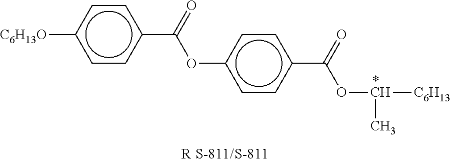

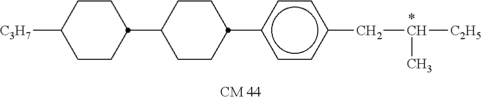

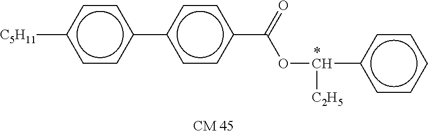

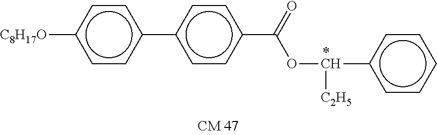

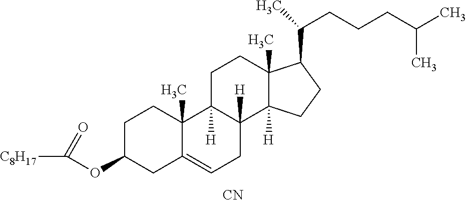

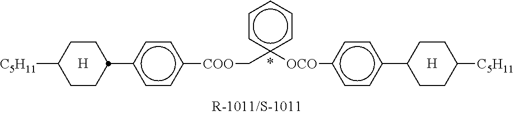

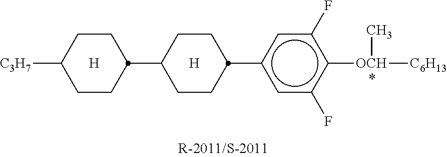

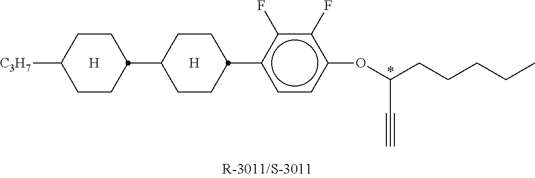

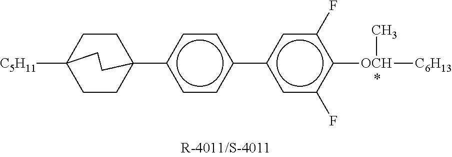

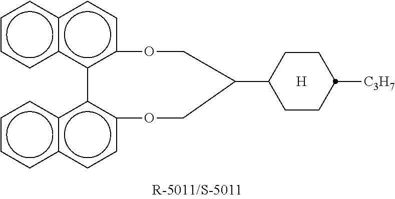

In a preferred embodiment of the present invention, the media according to the invention comprise one or more compounds selected from the group of the compounds from Table E.

Table F shows stabilisers which can preferably be employed in the mixtures according to the invention in addition to the compounds of the formula CC. The parameter n here denotes an integer in the range from 1 to 12. In particular, the phenol derivatives shown can be employed as additional stabilisers since they act as antioxidants.

TABLE F

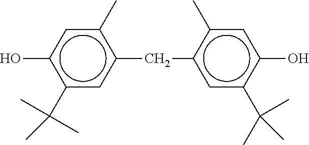

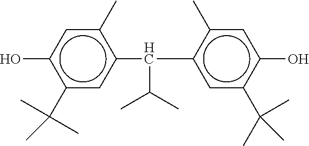

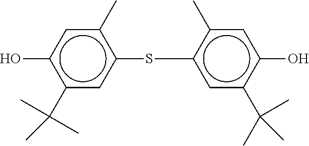

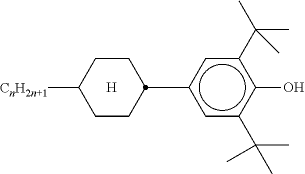

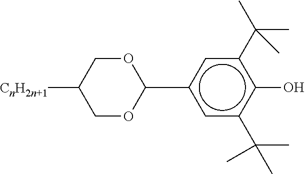

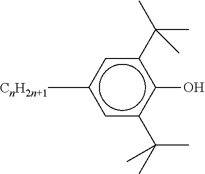

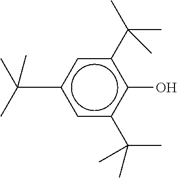

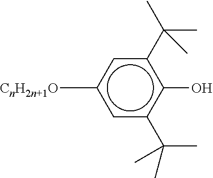

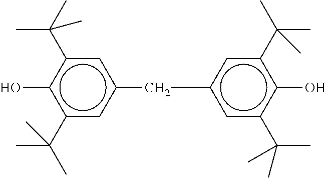

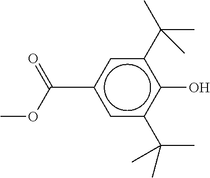

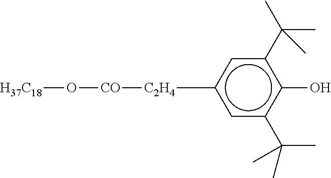

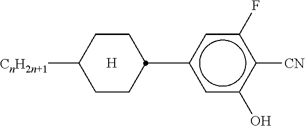

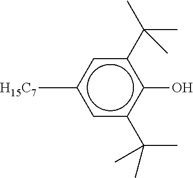

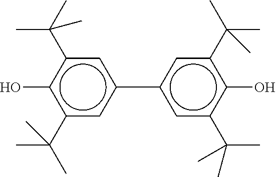

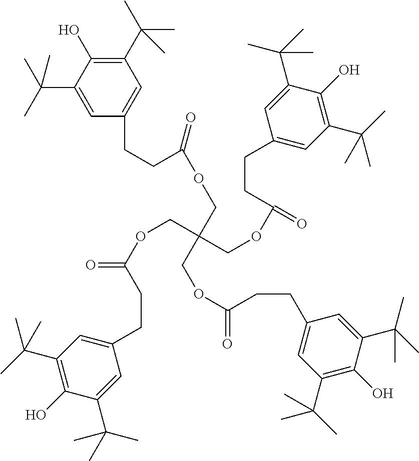 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

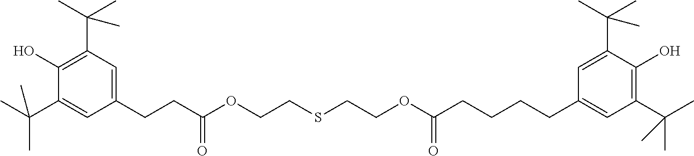 [SMILES: CC(C)(C)c1cc(CCCCC(=O)OCCSCCOC(=O)CCc2cc(C(C)(C)C)c(O)c(C(C)(C)C)c2)cc(C(C)(C)C)c1O]

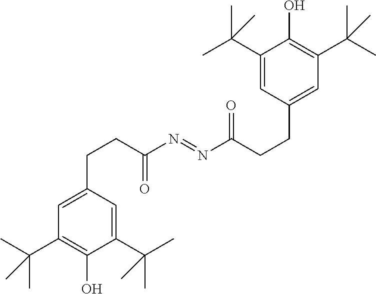 [SMILES: CC(C)(C)c1cc(CCC(=O)/N=N/C(=O)CCc2cc(C(C)(C)C)c(O)c(C(C)(C)C)c2)cc(C(C)(C)C)c1O]

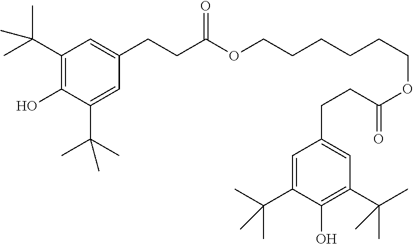 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

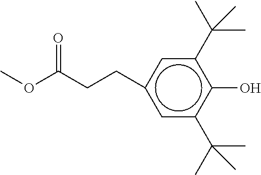

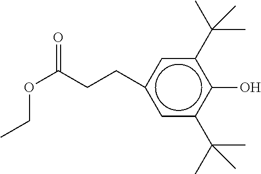

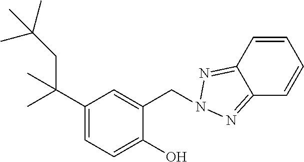 [SMILES: CC(C)(C)CC(C)(C)c1ccc(O)c(Cn2nc3ccccc3n2)c1]

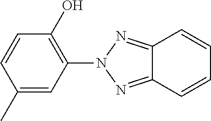 [SMILES: Cc1ccc(O)c(-n2nc3ccccc3n2)c1]

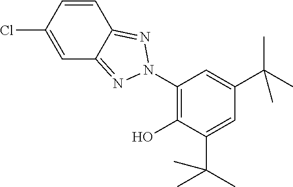 [SMILES: CC(C)(C)c1cc(-n2nc3ccc(Cl)cc3n2)c(O)c(C(C)(C)C)c1]

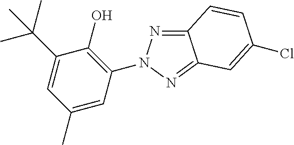 [SMILES: Cc1cc(-n2nc3ccc(Cl)cc3n2)c(O)c(C(C)(C)C)c1]

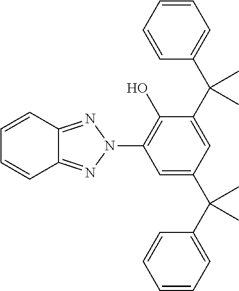 [SMILES: CC(C)(c1ccccc1)c1cc(-n2nc3ccccc3n2)c(O)c(C(C)(C)c2ccccc2)c1]

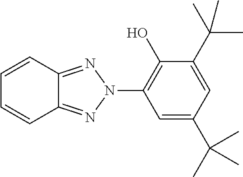 [SMILES: CC(C)(C)c1cc(-n2nc3ccccc3n2)c(O)c(C(C)(C)C)c1]

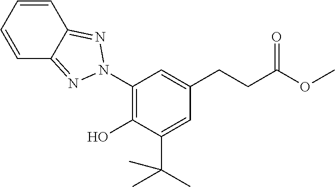 [SMILES: COC(=O)CCc1cc(-n2nc3ccccc3n2)c(O)c(C(C)(C)C)c1]

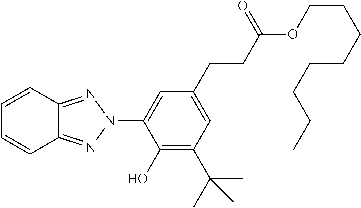 [SMILES: CCCCCCCCOC(=O)CCc1cc(-n2nc3ccccc3n2)c(O)c(C(C)(C)C)c1]

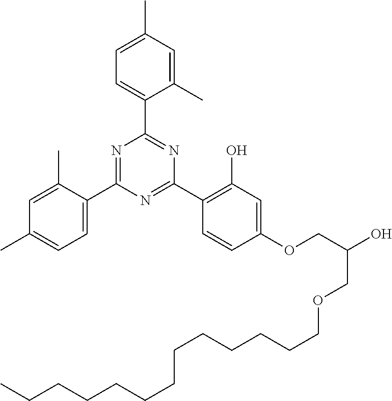 [SMILES: CCCCCCCCCCCCCOCC(O)COc1ccc(-c2nc(-c3ccc(C)cc3C)nc(-c3ccc(C)cc3C)n2)c(O)c1]

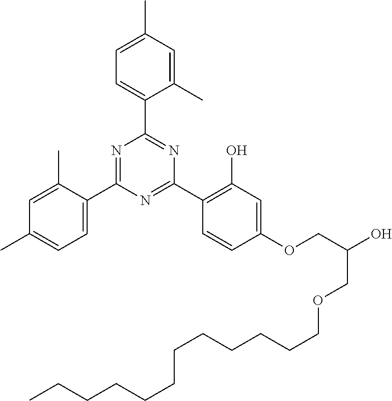 [SMILES: CCCCCCCCCCCCOCC(O)COc1ccc(-c2nc(-c3ccc(C)cc3C)nc(-c3ccc(C)cc3C)n2)c(O)c1]

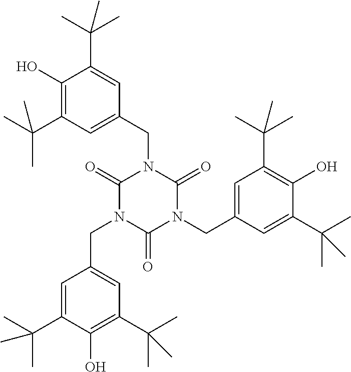 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

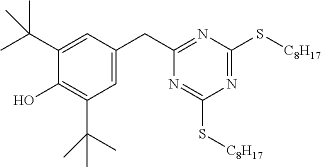

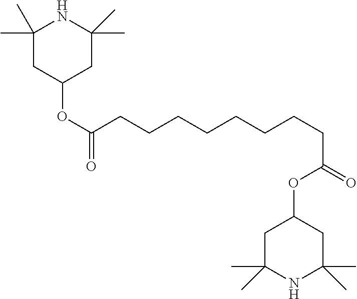

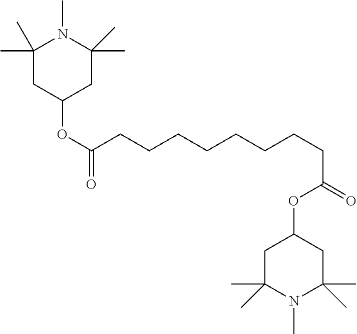

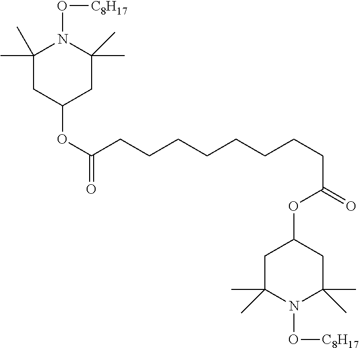

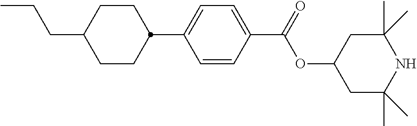

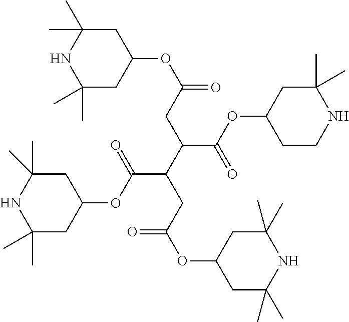

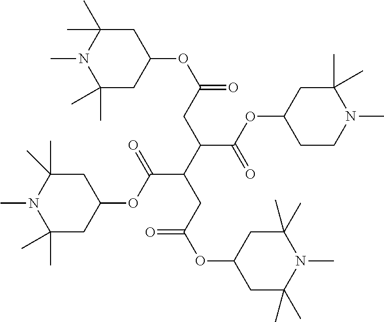

In a preferred embodiment of the present invention, the media according to the invention comprise one or more compounds selected from the group of the compounds from Table F.

The following examples are intended to explain the invention without limiting it. Above and below, percentage data denote percent by weight. All temperatures are indicated in degrees Celsius. m.p. denotes melting point, T_{(N,I)}=clearing point. Furthermore, C=crystalline state, N=nematic phase, S=smectic phase and I=isotropic phase. The data between these symbols represent the transition temperatures. Δn denotes optical anisotropy (589 nm, 20° C.), Δε denotes dielectric anisotropy (1 kHz, 20° C.); the flow viscosity ν₂₀ (mm²/sec) and the rotational viscosity γ₁ (mPa·s) were in each case determined at 20° C.

### EXAMPLE M1

| | | | |
|---|---|---|---|
| CCP-3-F | 12.0% | T_{(N, I)} [° C.]: | 135 |
| CCU-2-O1D | 15.0% | Δn: | 0.092 |
| CCU-3-O1D | 8.0% | Δε: | 8.2 |
| CCU-5-O1D | 14.0% | | |
| CCU-2-F | 7.0% | | |
| CCU-3-F | 12.0% | | |
| CCU-5-F | 5.0% | | |
| CCP-3-1 | 8.0% | | |
| CGPC-5-3 | 7.0% | | |
| CGPC-3-3 | 4.0% | | |
| CDUQU-3-F | 8.0% | | |

### EXAMPLE M2

| | | | |
|---|---|---|---|
| CCU-2-O1D | 15.0% | T_{(N, I)} [° C.]: | 121 |
| CCU-3-O1D | 8.0% | Δn: | 0.089 |
| CCU-5-O1D | 12.0% | Δε: | 7.1 |
| CCU-3-OD | 20.0% | | |
| CCU-4-OD | 20.0% | | |
| CCU-5-OD | 10.0% | | |
| CCP-3-1 | 8.0% | | |
| CGPC-5-3 | 5.0% | | |
| CGPC-3-3 | 2.0% | | |

### EXAMPLE M3

| | | | |
|---|---|---|---|
| CCG-1-F | 6.0% | T_{(N, I)} [° C.]: | 122 |
| CCG-2-F | 15.0% | Δn: | 0.087 |
| CCG-3-F | 16.0% | Δε: | 8.0 |
| CCG-5-F | 14.0% | γ₁ [mPa · s] | 216 |
| CCU-2-F | 7.0% | | |
| CCU-3-F | 10.0% | | |
| CCU-5-F | 5.0% | | |
| CCP-3-1 | 8.0% | | |
| CGPC-5-3 | 7.0% | | |
| CGPC-3-3 | 4.0% | | |
| CDUQU-3-F | 8.0% | | |

### EXAMPLE M4

| | | | |
|---|---|---|---|
| CCG-2-F | 10.0% | T_{(N, I)} [° C.]: | 122 |
| CCG-3-F | 25.0% | Δn: | 0.083 |
| CCG-5-F | 20.0% | Δε: | 7.4 |
| CCU-3-F | 6.0% | γ₁ [mPa · s] | 209 |
| CCQU-3-F | 15.0% | | |
| CCQU-5-F | 15.0% | | |
| CGPC-5-3 | 6.0% | | |
| CGPC-3-3 | 3.0% | | |

### EXAMPLE M5

| | | | |
|---|---|---|---|
| CCG-2-F | 10.0% | T_{(N, I)} [° C.]: | 123 |
| CCG-3-F | 20.0% | Δn: | 0.087 |
| CCG-5-F | 20.0% | Δε: | 7.5 |
| CCU-2-F | 6.0% | γ₁ [mPa · s] | 215 |
| CCU-3-F | 16.0% | | |
| CCU-5-F | 5.0% | | |
| CCP-3-1 | 10.0% | | |
| CCPU-3-F | 5.0% | | |
| CCPU-4-F | 5.0% | | |
| CCPU-5-F | 3.0% | | |

### EXAMPLE M6

| | | | |
|---|---|---|---|
| CCG-2-F | 10.0% | T_{(N, I)} [° C.]: | 120 |
| CCG-3-F | 25.0% | Δn: | 0.083 |
| CCG-5-F | 25.0% | Δε: | 8.2 |
| CCQU-3-F | 15.0% | γ₁ [mPa · s] | 207 |
| CCQU-5-F | 15.0% | | |
| CCPU-3-F | 5.0% | | |
| CCPU-4-F | 5.0% | | |

### EXAMPLE M7

| | | | |
|---|---|---|---|
| CCG-2-F | 10.0% | T_{(N, I)} [° C.]: | 123 |
| CCG-3-F | 25.0% | Δn: | 0.083 |
| CCG-5-F | 25.0% | Δε: | 7.4 |
| CCP-3-CI | 10.0% | γ₁ [mPa · s] | 209 |
| CCP-5-CI | 10.0% | | |
| CCQU-3-F | 15.0% | | |
| CCQU-5-F | 15.0% | | |

### EXAMPLE M8

| | | | |
|---|---|---|---|
| CCG-3-F | 10.0% | T_{(N, I)} [° C.]: | 131 |
| CCG-5-F | 20.0% | Δn: | 0.086 |
| CCP-3-CI | 12.0% | Δε: | 7.6 |
| CCP-5-CI | 18.0% | γ₁ [mPa · s] | 237 |
| CCQU-3-F | 15.0% | | |
| CCQU-5-F | 15.0% | | |
| CCU-3-F | 10.0% | | |

### EXAMPLE M9

| | | | |
|---|---|---|---|
| CCG-2-F | 10.0% | T_{(N, I)} [° C.]: | 143 |
| CCG-3-F | 20.0% | Δn: | 0.095 |
| CCG-5-F | 20.0% | Δε: | 5.8 |
| CCP-2-CI | 15.0% | γ₁ [mPa · s] | 255 |
| CCP-3-CI | 15.0% | | |
| CCP-5-CI | 20.0% | | |

### EXAMPLE M10

| | | | |
|---|---|---|---|
| CCG-2-F | 5.0% | T_{(N, I)}. [° C.]: | 124 |
| CCG-3-F | 20.0% | Δn: | 0.084 |
| CCP-2-CI | 15.0% | Δε: | 3.9 |
| CCP-3-CI | 15.0% | γ₁ [mPa · s] | 151 |
| CCP-5-CI | 20.0% | | |
| CC-2-3 | 10.0% | | |
| CC-3-4 | 10.0% | | |
| CC-3-5 | 5.0% | | |

### EXAMPLE M11

| | | | |
|---|---|---|---|
| CCG-3-F | 20.0% | T_{(N, I)} [° C.]: | 124 |
| CCG-5-F | 16.0% | Δn: | 0.080 |
| CCQU-3-F | 15.0% | Δε: | 7.9 |
| CCQU-5-F | 15.0% | γ₁ [mPa · s] | 185 |
| CC-3-4 | 10.0% | | |
| CC-4-5 | 5.0% | | |
| CGPC-3-3 | 4.0% | | |
| CGPC-5-3 | 7.0% | | |
| CDUQU-3-F | 8.0% | | |

### EXAMPLE M12

| | | | |
|---|---|---|---|
| CCEG-1-F | 16.0% | T_{(N, I)} [° C.]: | 121 |
| CCEG-3-F | 12.0% | Δn: | 0.0915 |
| CCEG-4-F | 12.0% | Δε: | 8.2 |
| CCU-2-F | 7.0% | γ₁ [mPa · s] | 276 |
| CCU-3-F | 15.0% | | |
| CCU-5-F | 5.0% | | |
| CCGU-3-F | 6.0% | | |
| CCP-3-1 | 8.0% | | |
| CGPC-5-3 | 7.0% | | |
| CGPC-3-3 | 4.0% | | |
| CDUQU-3-F | 8.0% | | |

### EXAMPLE M13

| | | | |
|---|---|---|---|
| CCU-1-F | 5.0% | T_{(N, I)} [° C.]: | 121 |
| CCU-2-F | 7.0% | Δn: | 0.0915 |
| CCU-3-F | 10.0% | Δε: | 8.2 |
| CCU-5-F | 5.0% | γ₁ [mPa · s] | 276 |
| CCGU-3-F | 6.0% | | |
| CCP-3-1 | 8.0% | | |
| CGPC-5-3 | 7.0% | | |
| CGPC-3-3 | 4.0% | | |
| CDUQU-3-F | 8.0% | | |
| CCEP-1-F | 25.0% | | |
| CCEP-4-F | 15.0% | | |

### EXAMPLE M14

| | | | |
|---|---|---|---|
| CCEG-1-F | 15.0% | T_{(N, I)} [° C.]: | 121 |
| CCEG-3-F | 15.0% | Δn: | 0.0893 |
| CCEG-4-F | 20.0% | Δε: | 6.2 |
| CCU-2-F | 7.0% | γ₁ [mPa · s] | 265 |
| CCU-3-F | 15.0% | | |
| CCU-5-F | 4.0% | | |
| CCGU-3-F | 5.0% | | |
| CCP-3-1 | 8.0% | | |
| CGPC-5-3 | 7.0% | | |
| CGPC-3-3 | 4.0% | | |

### EXAMPLE M15

| | | | |
|---|---|---|---|
| CCQU-3-F | 15.0% | T_{(N, I)} [° C.]: | 121 |
| CCQU-5-F | 8.0% | Δn: | 0.0878 |
| CCU-2-F | 15.0% | Δε: | 10.1 |
| CCU-3-F | 20.0% | γ₁ [mPa · s] | 249 |
| CCU-5-F | 8.0% | | |
| CCGU-3-F | 5.0% | | |
| CCP-3-1 | 8.0% | | |
| CGPC-5-3 | 7.0% | | |
| CGPC-3-3 | 5.0% | | |
| CDUQU-3-F | 3.0% | | |

### EXAMPLE M16

| | | | |
|---|---|---|---|
| CDU-2-F | 10.0% | T_{(N, I)} [° C.]: | 121 |
| CDU-3-F | 15.0% | Δn: | 0.0885 |
| CDU-5-F | 20.0% | Δε: | 13.2 |
| CCQU-3-F | 10.0% | γ₁ [mPa · s] | 280 |
| CCQU-5-F | 10.0% | | |
| CCGU-3-F | 8.0% | | |
| CCP-3-1 | 8.0% | | |
| CGPC-5-3 | 7.0% | | |
| CGPC-3-3 | 5.0% | | |
| CDUQU-3-F | 7.0% | | |

### EXAMPLE M17

| | | | |
|---|---|---|---|
| CCEU-2-F | 6.0% | T_{(N, I)} [° C.]: | 121 |
| CCEU-3-F | 15.0% | Δn: | 0.0885 |
| CCEU-5-F | 20.0% | Δε: | 6.3 |
| CCEG-3-F | 12.0% | γ₁ [mPa · s] | 253 |
| CCEP-3-F | 12.0% | | |
| CCQU-5-F | 10.0% | | |
| CCP-3-1 | 8.0% | | |
| CGPC-5-3 | 7.0% | | |
| CGPC-3-3 | 5.0% | | |
| CP-3-CI | 5.0% | | |

### EXAMPLE M18

| | | | |
|---|---|---|---|
| CCG-2-F | 10.0% | T_{(N, I)} [° C.]: | 143 |
| CCG-3-F | 25.0% | Δn [589 nm, 20° C.]: | 0.0934 |
| CCG-5-F | 25.0% | nₑ [589 nm, 20° C.]: | 1.5700 |
| CCQU-3-F | 15.0% | ε_{∥} [1 kHz, 20° C.]: | 15.2 |
| CCQU-5-F | 15.0% | ε_{⊥}[1 kHz, 20° C.]: | 3.6 |
| CCPU-3-F | 5.0% | Δε [1 kHz, 20° C.]: | 11.6 |
| CCPU-4-F | 5.0% | K₁ [pN, 20° C.]: | 15.6 |
| | | K₃ [pN, 20° C.]: | 23.8 |
| | | K₃/K₁ [pN, 20° C.]: | 1.53 |
| | | V₀ [V, 20° C.]: | 1.22 |
| | | γ₁ [mPa · s, 20° C.]: | 329 |
| | | LTS bulk [h, −20° C.]: | 1000 |
| | | LTS bulk [h, −30° C.]: | 72 |

1. Liquid-crystalline medium, characterised in that it comprises one or more compounds of the formula CC 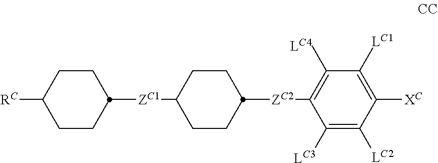
in which
R^{C} denotes an alkyl, alkenyl or alkoxy radical having 1 to 15 C atoms, in which a methylene group may be replaced by 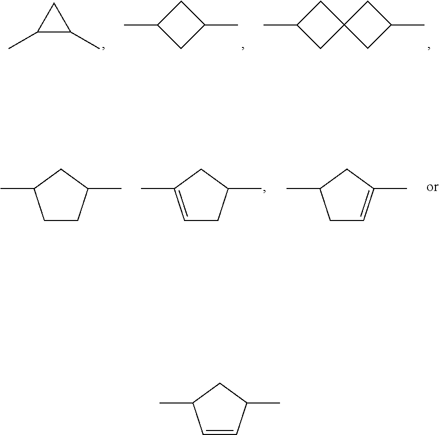
and in which in each case one or more H atoms may be replaced by F,
X^{C} denotes F, Cl, a halogenated alkyl radical, a halogenated alkenyl radical, a halogenated alkoxy radical or a halogenated alkenyloxy radical having up to 6 C atoms,
Z^{C1}, Z^{C2}, independently of one another, denote —CH₂CH₂— or a single bond,
L^{C1} and L^{C2}, independently of one another, denote H or F,
L^{C3} and L^{C4} independently of one another, denote H or methyl;
and characterised in that the medium has a clearing point of 120° C. or more.

2. Medium according to claim 1, where the total concentration of the one or more compounds of the formula CC in the medium is 55% by weight or more.

3. Medium according to claim 1, where the medium has a birefringence in the range from 0.060 to 0.100 at 20° C. and a wavelength of 589.3 nm.

4. Medium according to claim 1, where the medium comprises one or more compounds of the formula CP 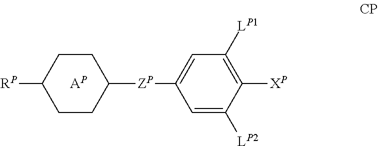
in which
R^{P} denotes an alkyl, alkenyl or alkoxy radical having 1 to 15 C atoms, in which a methylene group may be replaced by 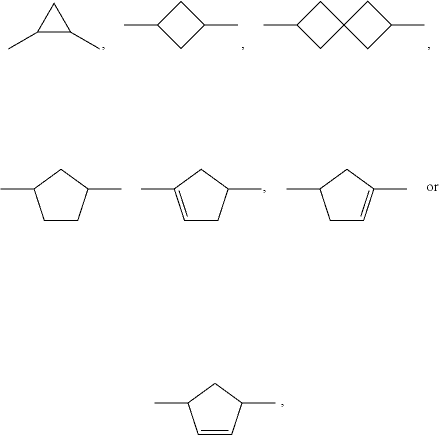
and in which in each case one or more H atoms may be replaced by F,
A^{P} denotes 1,4-cyclohexylene, in which one or two nonadjacent CH₂ groups may be replaced by —O—, or 1,4-phenylene, in which one or two CH groups may be replaced by N,
X^{P} denotes F, Cl, a halogenated alkyl radical, a halogenated alkenyl radical, a halogenated alkoxy radical or a halogenated alkenyloxy radical having up to 6 C atoms,
Z^{P}, independently of one another, denotes —CH₂CH₂— or a single bond,
L^{P1} and L^{P2}, independently of one another, denote H or F
in a total concentration of 2% or less.

5. Medium according to claim 1, where the medium comprises one or more compounds of the formula IV-1 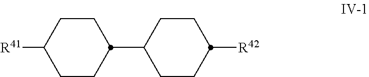
in which
R⁴¹ denotes alkyl having up to 7 C atoms and
R⁴² denotes alkyl or alkoxy, each having up to 7 C atoms,
or
R⁴¹ denotes alkenyl having up to 7 C atoms and R⁴² denotes alkyl or alkenyl, each having up to 7 C atoms,
where one or more H atoms in the radicals R⁴¹ and R⁴² may be replaced by F,
in a total concentration of 25% or less.

6. Medium according to claim 1, where the medium comprises one or more compounds of the formula CC selected from the group of the compounds CC-1 to CC-12 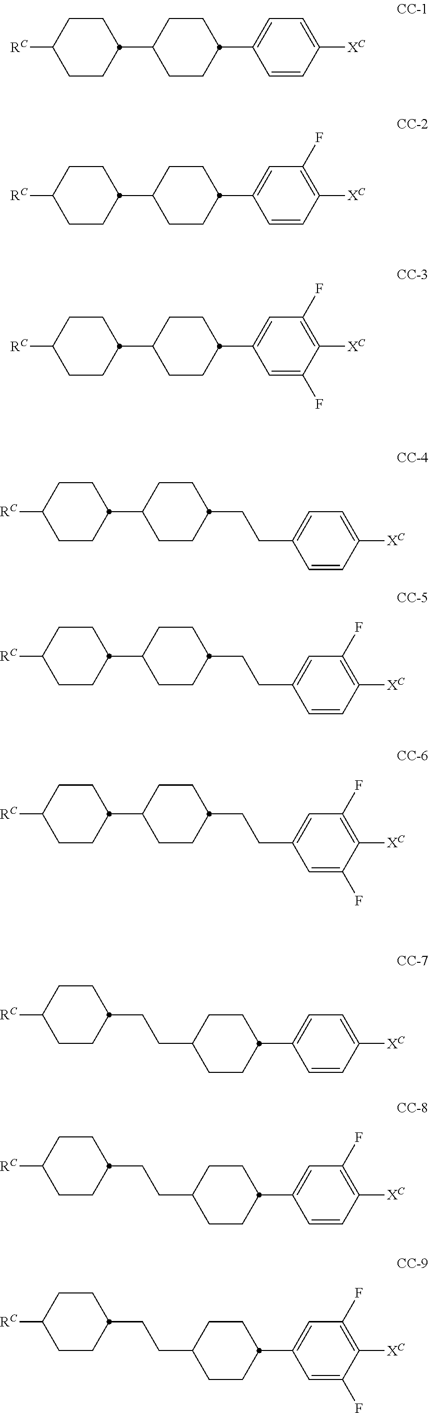 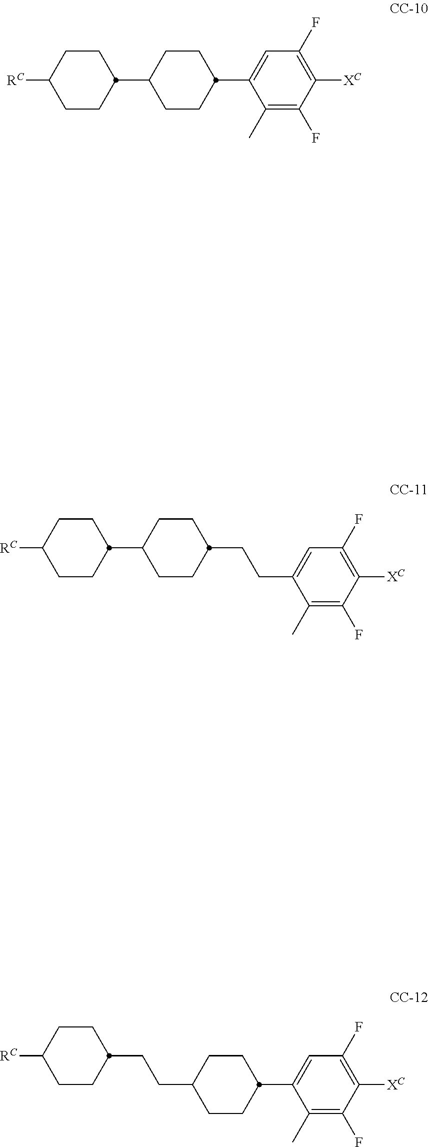
in which R^{C} and X^{C} have the meanings indicated for the compound of formula CC.

7. Medium according to claim 1, characterised in that it additionally comprises one or more compounds of the formula II in a total concentration of 40% or less, 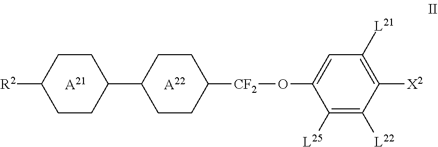
in which
R² denotes an alkyl or alkoxy radical having 1 to 15 C atoms, in which a methylene group may be replaced by 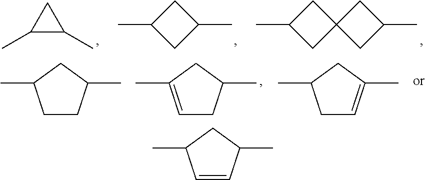
and in which one or more H atoms may be replaced by F, 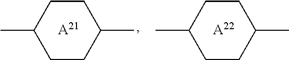
on each occurrence, identically or differently, denote 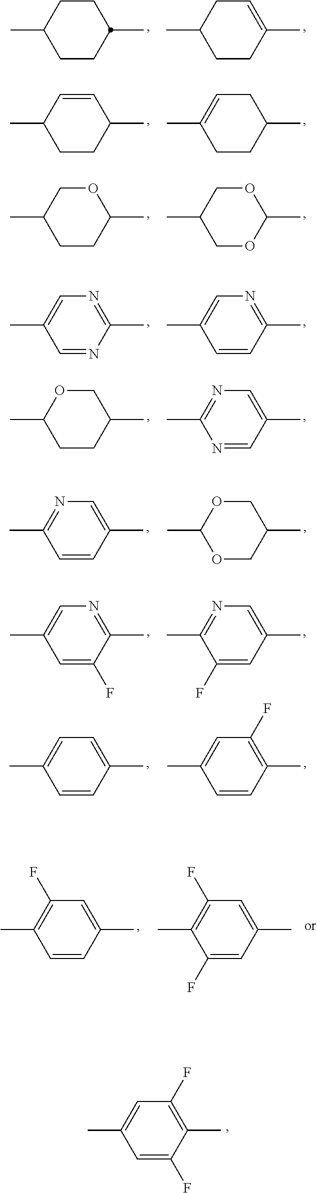
L²¹ and L²², independently of one another, denote H or F,
L²⁵ denotes H or methyl,
X² denotes F, Cl, CN, a halogenated alkyl radical, a halogenated alkenyl radical, a halogenated alkoxy radical or a halogenated alkenyloxy radical having 1 to 6 C atoms.

8. Medium according to claim 7, where the compounds of the formula II are selected from the group of the compounds II-1 to II-6 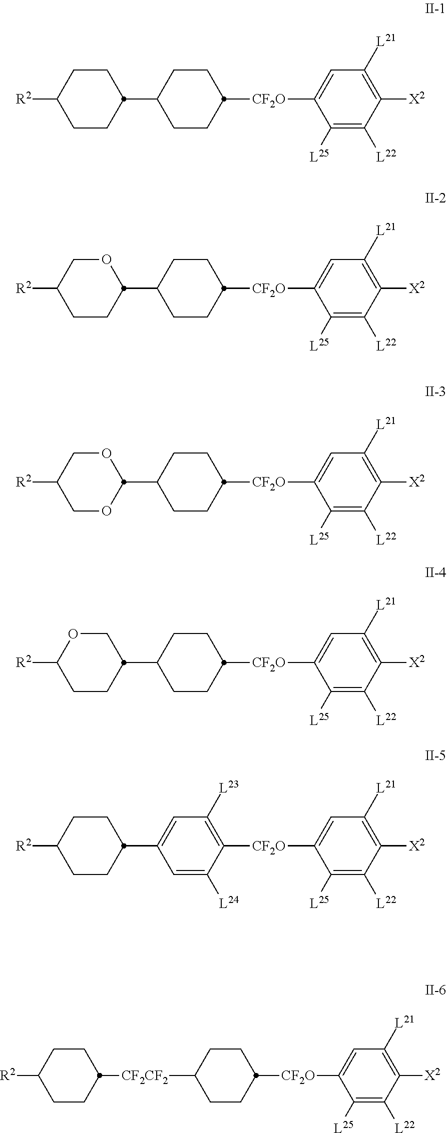
in which
R² denotes n-alkyl having 1 to 7 C atoms, in which a methylene group may be replaced by 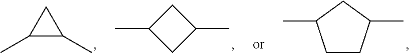
wherein in each of the radicals one or more H atoms may be replaced by F,
L²¹, L²²,
L²³ and L²⁴, independently of one another, denote H or F,
L²⁵ H or methyl, and
X² denotes F, Cl, halogenated alkyl or halogenated alkoxy having 1 to 6 C atoms.

9. Medium according to claim 1, characterised in that it additionally comprises one or more compounds selected from the group of the compounds of the formulae IA and IIB, 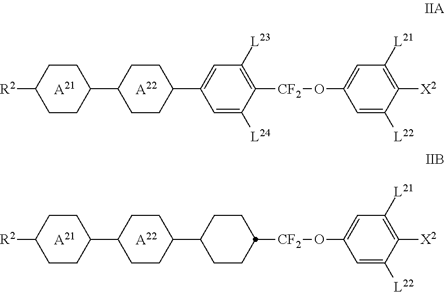
in which
R² denotes an alkyl or alkoxy radical having 1 to 15 C atoms, in which a methylene group may be replaced by 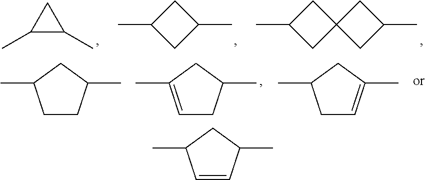
and in which one or more H atoms may be replaced by F, 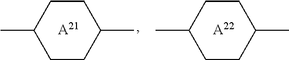
on each occurrence, identically or differently, denote 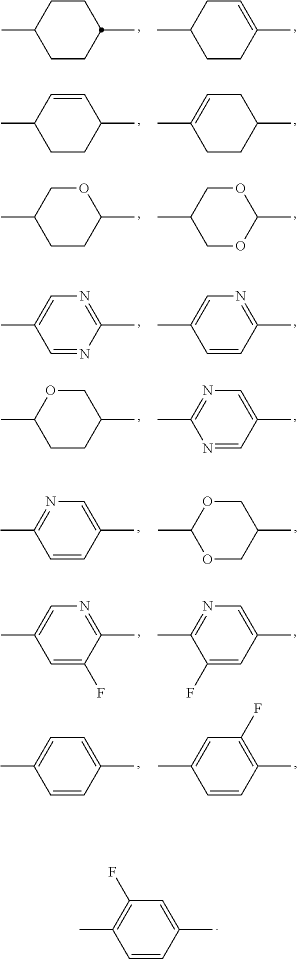 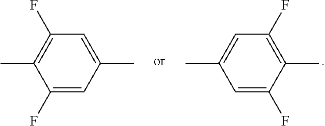
L²¹, L²²,
L²³ and L²⁴ independently of one another, denote H or F, and
X² denotes F, Cl, CN, a halogenated alkyl radical, a halogenated alkenyl radical, a halogenated alkoxy radical or a halogenated alkenyloxy radical having 1 to 6 C atoms.

10. Medium according to claim 1, characterised in that it additionally comprises one or more compounds of the formula III, 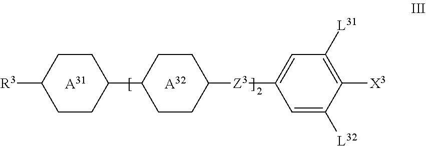
in which
R³ denotes an alkyl or alkoxy radical having 1 to 15 C atoms, in which a methylene group may be replaced by 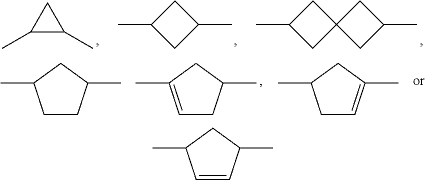
and in which one or more H atoms may be replaced by F, 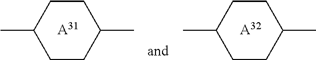
on each occurrence, independently of one another, denote 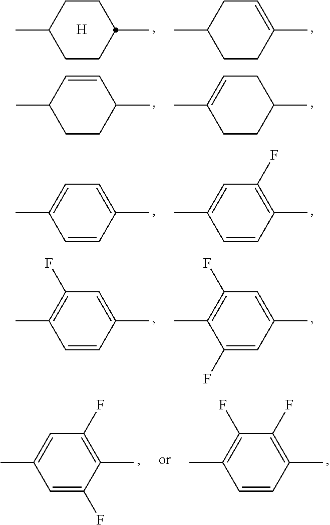
Z³ on each occurrence, independently of one another, denotes —CH₂CH₂—, —COO—, trans- —CH═CH—, trans-CF═CF—, —CH₂O—, —C≡C— or a single bond,
L³¹, L³² denote H or F,
X³ denotes F, Cl, CN, a halogenated alkyl radical, a halogenated alkenyl radical, a halogenated alkoxy radical or a halogenated alkenyloxy radical having up to 6 C atoms.

11. Medium according to claim 10, where the compounds of the formula III are selected from the compounds of the formulae III-1 to III-9 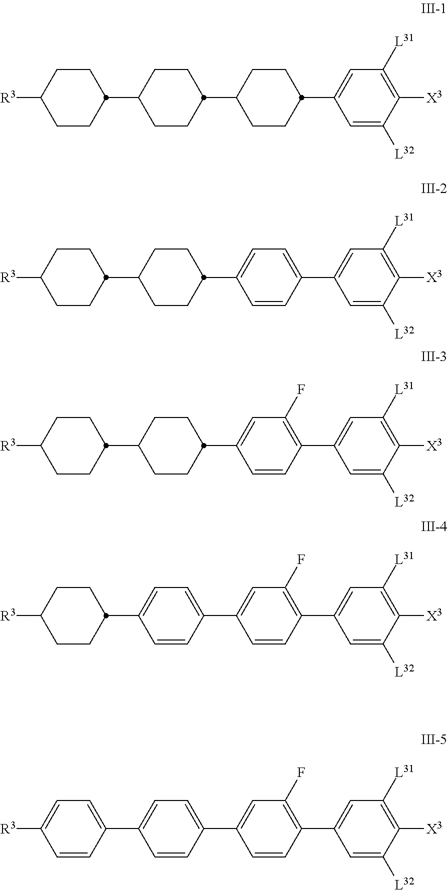 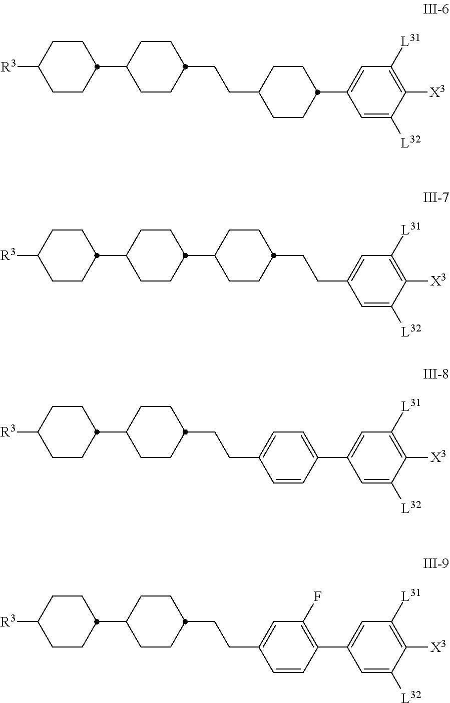
in which
R³, L³¹ and L³² have the meanings indicated for the compound of formula III,
and
X³ denotes F, Cl, halogenated alkyl or halogenated alkoxy having up to 6 C atoms.

12. Medium according to claim 1, characterised in that it additionally comprises one or more compounds selected from the group of the compounds of the formulae IV-11 and IV-12 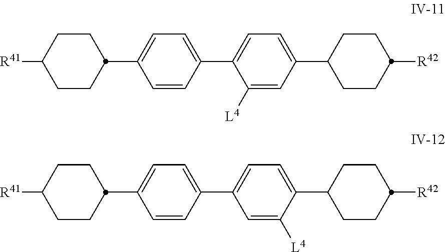
in which
R⁴¹ and R⁴², independently of one another, denote n-alkyl having 1 to 7 C atoms, and
L⁴ denotes H or F.

13. An electro-optical product, comprising the medium according to claim 1.

14. A liquid-crystal light valve in a lighting device for a vehicle or in a liquid-crystal display, comprising the medium according to claim 1.

15. Electro-optical component containing a liquid-crystalline medium according to claim 1.

16. Electro-optical component according to claim 15, where the component is a liquid-crystal light valve.

17. Lighting device for vehicles containing an electro-optical component according to claim 15.

18. Liquid-crystal display containing an electro-optical component according to claim 15.
